(19) United States
(12) Patent Application Publication
(10) Pub. No.: US 2019/0196137 A1
(43) Pub. Date: Jun. 27, 2019

(54) LENS DRIVE UNIT

(71) Applicant: CM Technology Co., Ltd., Tokyo (JP)

(72) Inventor: Yutaka USHIODA, Tokyo (JP)

(73) Assignee: CM Technology Co., Ltd., Tokyo (JP)

(21) Appl. No.: 16/021,790

(22) Filed: Jun. 28, 2018

(30) Foreign Application Priority Data
Dec. 22, 2017 (JP) 2017-245778

(51) Int. Cl. G02B 7/09; G03B 13/36; G03B 5/00; G02B 27/64

(52) U.S. Cl. CPC G02B 7/09; G03B 13/36; G03B 2205/0007; G02B 27/648; G03B 2205/0069; G03B 5/00

(57) ABSTRACT

A lens drive unit according to the present invention includes: a voice coil motor installed around a lens barrel equipped with a lens, and configured to move the lens barrel along an optical axis of the lens; and a guide part configured to guide movement of the lens barrel along the optical axis of the lens with respect to a housing configured to house the lens barrel. The voice coil motor includes a magnet installed on one of the housing and the lens barrel, and a coil and a yoke configured to concentrate a magnetic flux of the magnet that are installed on the other. The yoke is placed so as to press the lens barrel against the guide part by a magnetic force by which the yoke is attracted to the magnet.

### TECHNICAL FIELD

The present invention relates to a lens drive unit. Specifically, the present invention relates to a lens drive unit that has an autofocus function.

### BACKGROUND ART

A recent information processing terminal such as a smartphone and a tablet terminal is equipped with a compact camera module for taking an image. Such a camera module includes a lens drive unit that has an autofocus function to automatically focus at the time of taking an image of an object.

The autofocus function of the lens drive unit is realized by a voice coil motor including a magnet and a coil as shown in Patent Document 1, for example. Use of a drive force of the voice coil motor allows a lens to reciprocate along the optical axis direction. With this, the lens drive unit supports the reciprocation of the lens along the optical axis direction by the autofocus function with the use of a guide ball placed around.

Patent Document 1: Japanese Unexamined Patent Application Publication No. JP-A 2015-180937

In the lens drive unit having the autofocus function described above, there is a need to cause the lens to reciprocate in a stable manner when the lens moves along the optical axis direction. That is, there is a need to inhibit instability of the optical axis of the lens caused by the motion. Therefore, it is desired to increase stability of the lens during the reciprocation.

### SUMMARY OF THE INVENTION

A lens drive unit as an aspect of the present includes:

a voice coil motor installed around a lens barrel equipped with a lens, the voice coil motor being configured to move the lens barrel along an optical axis of the lens; and

a guide part configured to guide movement of the lens barrel along the optical axis of the lens with respect to a housing configured to house the lens barrel.

The voice coil motor includes a magnet that is installed on one of the housing and the lens barrel and a coil and a yoke that are installed on the other, and the yoke is configured to concentrate a magnetic flux produced by the magnet.

The yoke is placed so as to press the lens barrel against the guide part by a magnetic force by which the yoke is attracted to the magnet.

Moreover, in the lens drive unit:

at least two voice coil motors are arranged around the lens barrel; and

yokes included by the at least two voice coil motors are arranged so as to press the lens barrel against the guide part by a resultant force of magnetic forces by the yokes.

Moreover, in the lens drive unit:

the guide part is placed in a middle position between the two voice coil motors around the lens barrel; and

the yokes included by the two voice coil motors are arranged so as to press the lens barrel against the guide part by a resultant force of magnetic forces by the yokes.

Moreover, in the lens drive unit, the voice coil motors are installed in positions corresponding to centers of neighboring side walls of the housing that has a rectangular shape.

Moreover, in the lens drive unit, the yoke is formed so that its portion on a side where the guide part is located is larger in cross section than its portion on a side where the guide part is not located.

Moreover, in the lens drive unit, the yoke has a T-shaped form and is installed so that a head part of the T-shaped form is placed closer to the guide part.

Moreover, in the lens drive unit, a magnetic force by which the yoke included by the voice coil motor installed on one of the neighboring side walls of the housing is attracted to the magnet is different from a magnetic force by which the yoke included by the voice coil motor installed on the other is attracted to the magnet.

Moreover, in the lens drive unit, a thickness of the yoke included by the voice coil motor installed on one of the neighboring side walls of the housing that has the rectangular shape is different from a thickness of the yoke included by the voice coil motor installed on the other.

Moreover, the lens drive unit further includes a second guide part on an opposite side from the guide part across the lens barrel.

The second guide part includes a guide ball and a retaining member that is configured to retain the guide ball in a rotatable manner and a guide ball support part against which the guide ball is pressed by the retaining member, the guide ball and the retaining member and the guide ball support part are arranged so that the retaining member retains the guide ball from one side with respect to a line passing through a center of the lens and connecting the guide part with the second guide part and so that the guide ball support part is located on the other side.

The thickness of the yoke is regulated so that the retaining member presses the guide ball against the guide ball support part by a magnetic force by which the yoke is attracted to the magnet.

Moreover, in the lens drive unit:

the voice coil motors are placed on a side where the retaining member is placed and on a side where the guide ball support part is placed, respectively, with respect to the line passing through the center of the lens and connecting the guide part with the second guide part; and the thicknesses of the yokes are regulated so that the yoke of the voice coil motor on the side where the retaining member is placed is thinner than the yoke of the voice coil motor on the side where the guide ball support part is placed.

Moreover, in the lens drive unit, the yoke and the magnet are placed so that a position of the lens barrel with respect to the housing becomes a predetermined position with magnetic levitation by the yoke and the magnet.

Further, the present invention also provides a camera module equipped with the lens drive unit.

Further, a lens drive unit as an aspect of the present invention includes:

a lens barrel equipped with a lens;

a housing installed around the lens barrel and configured to house the lens barrel;

a first voice coil motor configured to move the lens barrel along an optical axis of the lens with respect to the housing; and

a first guide part configured to guide movement of the lens barrel with respect to the housing.

In the lens drive unit, the first voice coil motor includes a magnet that is installed on one of the housing and the lens barrel and also includes a coil and a yoke that are installed on the other, and the yoke is placed so as to press the lens barrel against the first guide part by a magnetic force by which the yoke is attracted to the magnet.

The lens drive unit further includes:

a support cover configured to support the housing on one face side of the lens;

a second voice coil motor configured to move the housing in a vertical direction to the optical axis of the lens with respect to the support cover;

a second guide part placed between the housing and the support cover so as to come in contact with the housing and the support cover and configured to guide movement of the housing with respect to the support cover; and

a connection member configured to connect the housing to the support cover.

In the lens drive unit, the second voice coil motor includes a magnet installed on one of the housing and the support cover and also includes a coil and a yoke installed on the other; and

the connection member is configured to connect the housing to the support cover with a constant distance kept.

Moreover, in the lens drive unit, the connection member is configured to apply a force attracting the housing and the support cover to each other via the second guide part.

Moreover, in the lens drive unit, the connection member is configured to be flexible in the vertical direction to the optical axis of the lens.

Moreover, in the lens drive unit, the connection member includes a tension spring configured to apply a force attracting the housing and the support cover to each other.

Moreover, in the lens drive unit, the second guide part includes a plurality of spherical objects arranged at positions previously set with respect to the support cover and configured to rotate at the arranged positions.

Moreover, in the lens drive unit, the second voice coil motor includes two voice coil motors configured to respectively move the housing in two linear directions orthogonal to each other on a vertical plane to the optical axis of the lens.

Moreover, in the lens drive unit:

the first voice coil motors are arranged at positions on two neighboring sides of the lens barrel having a substantially rectangular shape;

the first guide part is placed in a middle position between the two first voice coil motors; and

the yokes of the two first voice coil motors are arranged so as to press the lens barrel against the first guide part by a resultant force of magnetic forces by the respective yokes.

Moreover, in the lens drive unit:

the first guide part includes a main guide part and a sub guide part, the main guide part is placed near a corner between the two neighboring sides where the two first voice coil motors are arranged of the lens barrel having the substantially rectangular shape, and the sub guide part is placed near the other corner located diagonally to the corner where the main guide part is placed of the lens barrel having the substantially rectangular shape;

the magnetic forces by which the yokes included by the two first voice coil motors are attracted to the magnets are differentiated from each other; and

the sub guide part is configured to support press by the lens barrel urged to rotate about the main guide part by a resultant force of the magnetic forces by the respective yokes of the two first voice coil motors.

Moreover, in the lend drive unit, two voice coil motors serving as the second voice coil motor are arranged near positions on the other two sides that are different from the two neighboring sides where the first voice coil motors are arranged of the lens barrel having the substantially rectangular shape, and the two voice coil motors respectively move the housing in two linear directions orthogonal to each other on a vertical plane to the optical axis of the lens.

Further, the present invention also provides a camera module equipped with the lens drive unit.

Further, a lens drive unit as an aspect of the present invention includes:

a lens barrel equipped with a lens;

a housing installed around the lens barrel and configured to house the lens barrel;

a voice coil motor configured to move the lens barrel along an optical axis of the lens with respect to the housing; and

a guide mechanism configured to guide movement of the lens barrel along the optical axis of the lens with respect to the housing.

The guide mechanism includes a main guide part and a sub guide part, the main guide part is placed in a predetermined position around the lens barrel, and the sub guide part is placed in another position located opposite the predetermined position around the lens barrel where the main guide part is placed, across the lens barrel.

The voice coil motor includes a magnet installed on one of the housing and the lens barrel and also includes a coil and a yoke installed on the other, and is configured to apply a force pressing the lens barrel against the main guide part and a force by which the lens barrel pulls the housing via the sub guide part, by a magnetic force by which the yoke is attracted to the magnet.

Moreover, in the lens drive unit, the sub guide part includes a housed member housed in a concave formed on an inner face of the housing and configured to move along the optical axis of the lens in the concave part, and the sub guide part is configured so that the housed member is caught inside the housing and pulled toward the lens barrel.

Moreover, in the lens drive unit, an opening of the concave is formed so as to have a larger cross-sectional area than an internal space of the concave.

Moreover, in the lens drive unit, the sub guide part includes a sub guide ball serving as the housed member housed in the concave, a retaining part connected to the lens barrel and configured to retain the sub guide ball in a manner rotatable along the optical axis of the lens, and a pulling member configured to pull the sub guide ball toward the lens barrel.

Moreover, in the lens drive unit:

the retaining part is configured to extend so as to be inserted in the internal space of the concave from the outer perimeter of the lens barrel, thereby sandwiching and retaining the sub guide ball along the optical axis of the lens and also retaining the sub guide ball in a manner movable along a direction in which the retaining member extends; and

the pulling member is formed by a magnet that pulls the sub guide ball toward the lens barrel by a magnetic force, and is placed near a root of the retaining member located closer to the lens barrel than the concave part of the housing.

Moreover, the lens drive unit further includes a second voice coil motor configured to move the housing with the lens barrel housed in a vertical direction to the optical axis of the lens, and in the lens drive unit:

two voice coil motors are arranged near two neighboring sides of an outer perimeter of the lens barrel having a substantially rectangular shape;

two second voice coil motors are arranged near two neighboring sides of the outer perimeter of the lens barrel, different from where the voice coil motors are arranged;

the main guide part is placed near a corner between the two neighboring sides of the outer perimeter of the lens barrel where the two voice coil motors are arranged; and

the sub guide part is placed near another corner located diagonally to the corner of the lens barrel where the main guide part is placed, and the another corner is between the two neighboring sides of the outer perimeter of the lens barrel where the two second voice coil motors are arranged.

Further, the present invention provides a camera module equipped with two lens drive units adjacent to each other.

The two lens drive units are installed so that none of the second voice coil motors are located on at least one of sides where the lens drive units are located adjacent to each other.

Moreover, in the camera module, the two lens drive units are installed so that none of the second voice coil motors are located on sides where the lens drive units are located adjacent to each other.

According to the lens drive unit of the present invention, the lens barrel is pressed against the guide part that guides the movement of the lens barrel. Consequently, the lens barrel moves along the optical axis direction in a state pressed against the guide part. As a result, it is possible to increase stability at the time of movement of the lens barrel.

Further, according to the lens drive unit of the present invention, the lens barrel is pressed against the first guide part and movement in the optical axis direction is guided. Moreover, the housing that houses the lens barrel keeps a predetermined distance from the support cover, and movement in a direction vertical to the optical axis direction is guided by the second guide part. As a result, stability of movement of the lens can be increased by the autofocus function and the stabilizer function.

Further, according to the lens drive unit of the present invention, the lens barrel is pressed against the main guide part, and movement in the optical axis direction of the lens barrel is guided in a state that the lens barrel pulls the housing via the sub guide part. Thus, a position of the lens barrel in a vertical direction to the optical axis direction in the housing becomes stable, and stability of movement of the lens can be increased.

### BRIEF DESCRIPTION OF DRAWINGS

FIG. 1 is a view showing a configuration of a camera module in a first exemplary embodiment of the present invention;

FIG. 2 is a view for describing the configuration and operation of an autofocus function of a lens drive unit mounted on the camera module disclosed in FIG. 1;

FIG. 3 is a view showing an example of the shape of a yoke included by the camera module;

FIG. 4 is a view showing an example of a state where a lens barrel mounted on the camera module disclosed in FIG. 1 is pressed against a guide ball;

FIG. 5 is a view showing the configuration of a guide mechanism mounted on the camera module disclosed in FIG. 1;

FIG. 6 is a view showing an example of another configuration of the camera module;

FIG. 7 is a view showing an example of another configuration of the camera module;

FIG. 8 is a view showing a configuration of a camera module in a second exemplary embodiment of the present invention;

FIG. 9 is a view for describing an example of a stabilizer function;

FIG. 10 is a view showing a configuration of a camera module in a third exemplary embodiment of the present invention;

FIG. 11 is a view showing a configuration of a lens barrel included by the camera module;

FIG. 12 is a view showing a configuration of a housing included by the camera module;

FIG. 13 is a view showing a configuration of a cover and a bottom cover that are included by the camera module;

FIG. 14 is a view showing a configuration of an FPC included by the camera module;

FIG. 15 is a view showing a configuration of a magnet and a coil that are included by the camera module;

FIG. 16 is a view showing a configuration of a magnet and a coil that are included by the camera module;

FIG. 17 is a view showing a configuration of a yoke included by the camera module;

FIG. 18 is a view showing how the camera module is assembled;

FIG. 19 is a view showing an operation of the camera module;

FIG. 20 is a view showing an operation of the camera module;

FIG. 21 is a view showing a configuration of a camera module in a fourth exemplary embodiment of the present invention;

FIG. 22 is a magnified view showing a configuration of part of the camera module disclosed in FIG. 21;

FIG. 23 is a view showing components of the part of the camera module disclosed in FIG. 22;

FIG. 24 is a view showing an operation of the camera module disclosed in FIG. 21;

FIG. 25 is a view showing an operation of the camera module disclosed in FIG. 21;

FIG. 26 is a view showing an example of arrangement of a camera module in a fifth exemplary embodiment of the present invention;

FIG. 27 is a view showing an example of arrangement of the camera module in the fifth exemplary embodiment of the present invention; and

FIG. 28 is a view showing an example of arrangement of the camera module in the fifth exemplary embodiment of the present invention.

### EXEMPLARY EMBODIMENT

### First Exemplary Embodiment

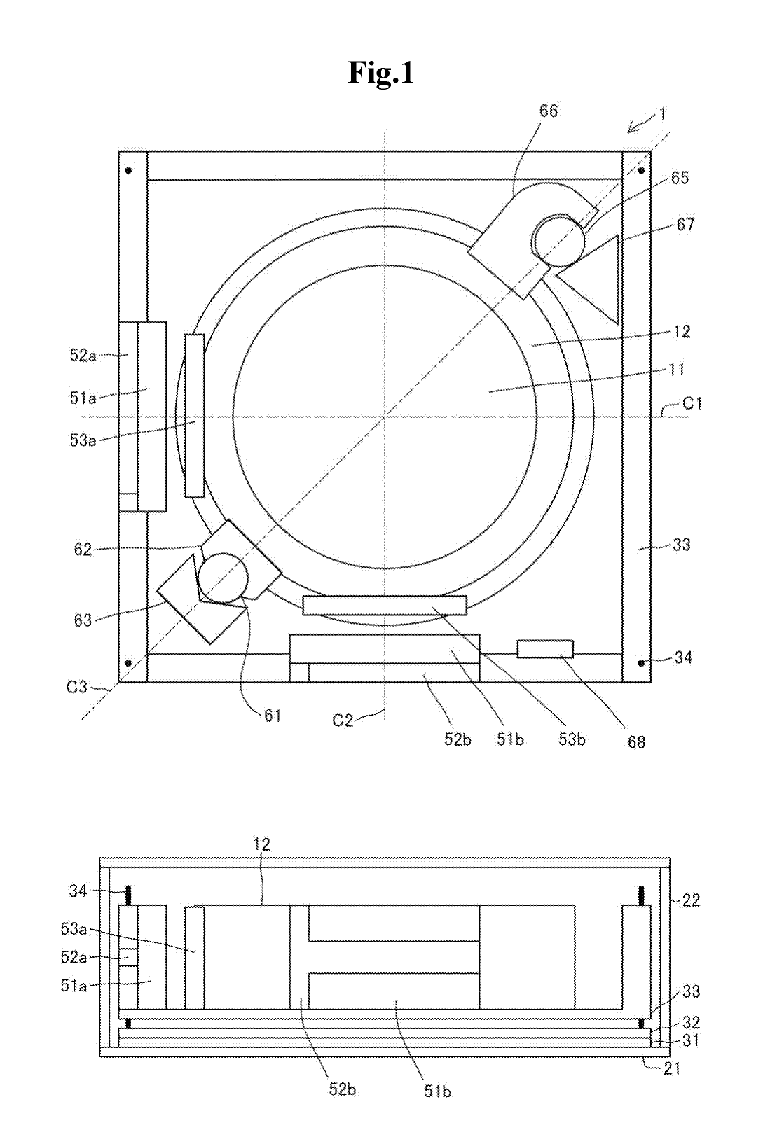

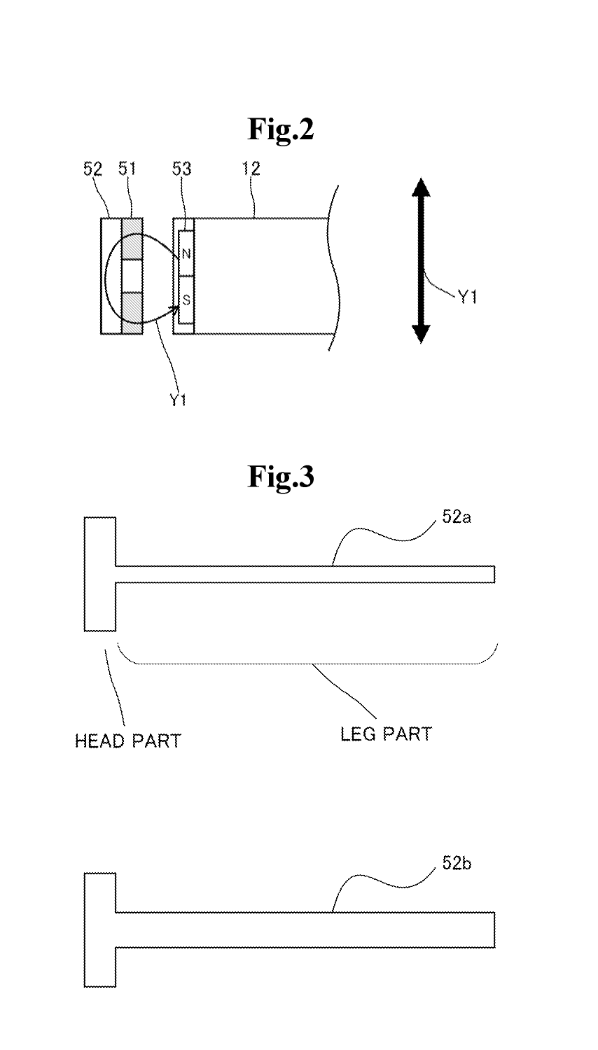

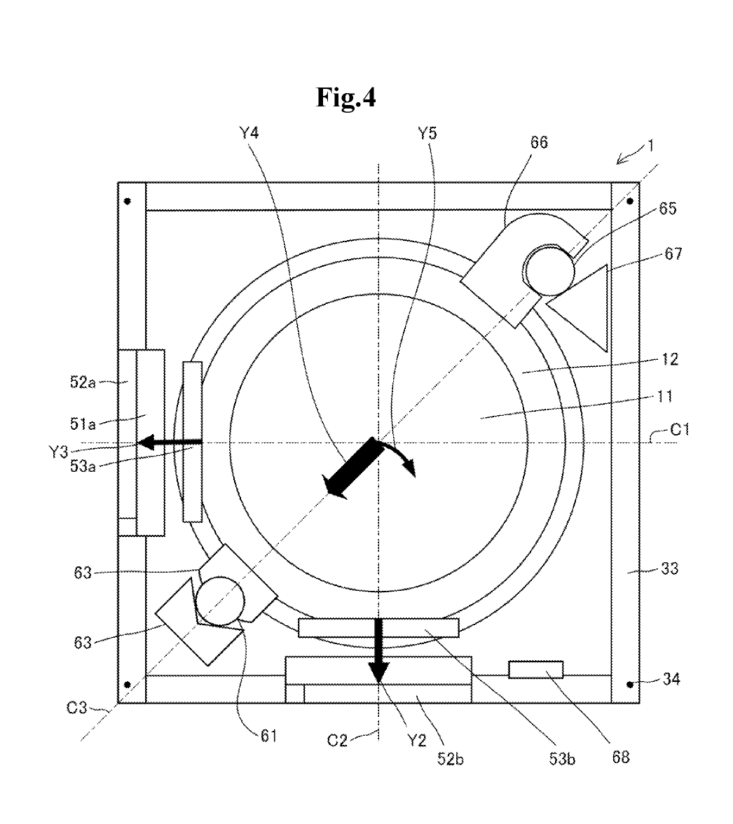

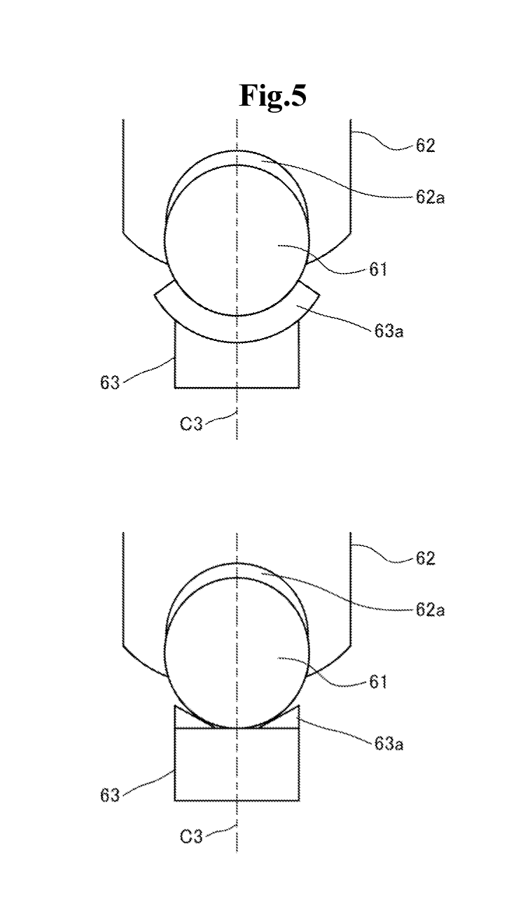

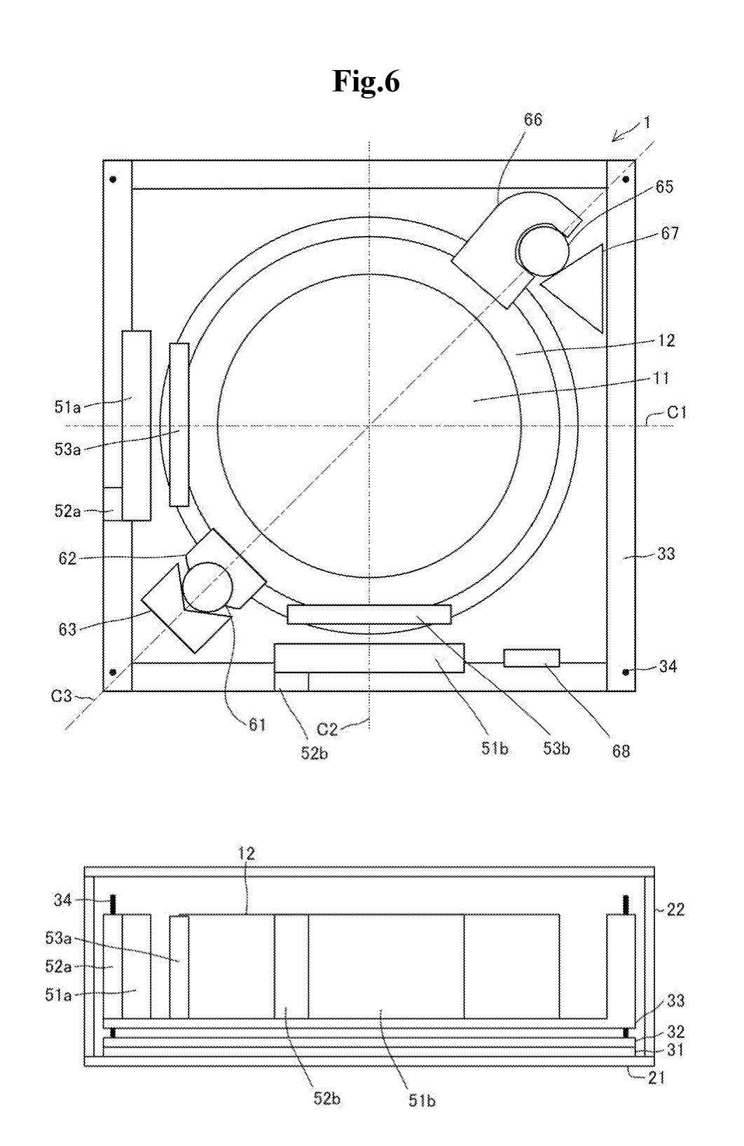

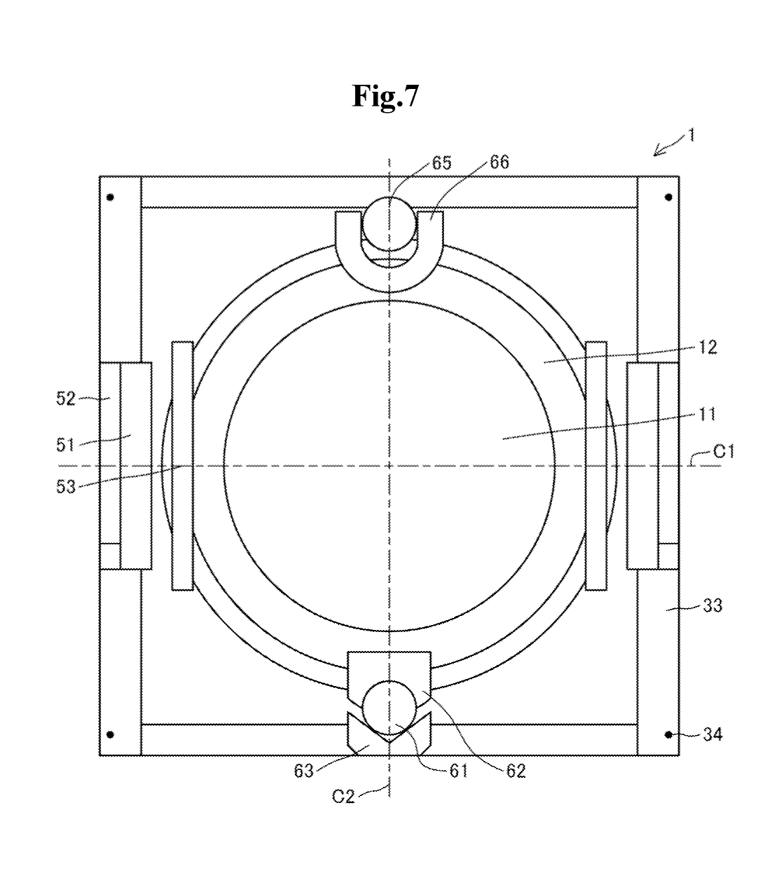

A first exemplary embodiment of the present invention will be described with reference to FIGS. 1 to 7. FIG. 1 is a view showing a configuration of a camera module 1. FIG. 2 is a view for describing the configuration and operation of an autofocus function of a lens drive unit mounted on the camera module 1. FIG. 3 is a view showing an example of the shape of a yoke included by the camera module 1. FIG. 4 is a view showing an example of a state where a lens barrel 12 mounted on the camera module 1 is pressed against a guide ball 61 and a guide ball 65. FIG. 5 is a view showing the configuration of a guide mechanism mounted on the camera module 1. FIGS. 6 and 7 are views showing examples of other configurations of the camera module 1.

The camera module 1 according to the present invention is, for example, for taking an image, mounted on an information processing terminal such as a smartphone and a tablet terminal. However, the camera module 1 according to the present invention is not necessarily limited to being mounted on an information processing terminal, and may be mounted on other electronic equipment or various types of equipment.

The camera module 1 includes a lens drive unit that has an autofocus function to automatically focus at the time of taking an image of an object. Hereinafter, a configuration of the lens drive unit that realizes the autofocus function will be mainly described. The lens drive unit may have a function other than the function illustrated in this exemplary embodiment, for example, may have a stabilizer function to optically compensate for camera shake occurring at the time of taking an image to reduce blur of the image.

First, the outline of the configuration of the camera module 1 will be described with reference to FIG. 1. The upper view of FIG. 1 is a view showing the inside of the camera module 1 taken from above. The lower view of FIG. 1 is a partial sectional view showing the inside of the camera module 1 taken from the lower side in the upper view of FIG. 1.

With reference to the lower view of FIG. 1, the camera module 1 is surrounded by a bottom substrate 21 and a cover 22. On the bottom substrate 21, a FPC (Flexible Printed Circuit) 31 having an imaging element and a FP coil (Fine Pattern coil) 32 are laminated.

Further, the camera module 1 has a rectangular housing 33 surrounded by a bottom part and side walls above the FP coil 32. The housing 33 houses the lens barrel 12 equipped with a lens 11, and the lens barrel 12 is, in planar view, located in a circular cutout part formed in the bottom part of the housing 33. The lens barrel 12 is supported in the housing 33 by the guide ball 61, the guide ball 65 and so on to be described later. The lens barrel 12 is then supported so that the direction of the optical axis of the lens 11 mounted on the lens barrel 12 is a direction vertical to the surface of paper in the upper view of FIG. 1 and is a direction along the surface of paper in the lower view of FIG. 1.

Further, the camera module 1 includes a lens drive unit that drives the lens barrel 12 equipped with the lens 11. The lens drive unit includes, as the configuration realizing the autofocus function, voice coil motors placed around the lens barrel 12. The voice coil motors are placed around the lens barrel 12, in positions corresponding to the middles of two neighboring side walls of the rectangular housing 33, respectively. That is, in this exemplary embodiment, as shown in the upper view of FIG. 1, one of the voice coil motors is placed on an extended line (a dashed-dotted line C1) of a predetermined diameter of the lens 11. Moreover, the other voice coil motor is placed on an extended line (a dashed-dotted line C2) of a diameter of the lens 11 that intersects the dashed-dotted line C1 at right angles.

The voice coil motors each include a coil 51 and a yoke 52 installed on the housing 33, and a magnet 53 installed on the lens barrel 12 so as to correspond to the coil 51 and the yoke 52. To be specific, the voice coil motor placed on the dashed-dotted line C1 includes a coil 51a, a yoke 52a and a magnet 53a, and the voice coil motor placed on the dashed-dotted line C2 includes a coil 51b, a yoke 52b and a magnet 53b. Hereinafter, when not particularly discriminated, the components will be referred to as the coil 51, the yoke 52 and the magnet 53.

Of the components described above, the coil 51a and the coil 51b have the same configurations, and the magnet 53a and the magnet 53b also have the same configurations. Moreover, as described later, both the yoke 52a and the yoke 52b have T-shaped forms and are different in thickness of long and thin leg parts of the T-shaped forms. Hereinafter, a detailed configuration and operation of the voice coil motors will be described with reference to FIG. 2.

As shown in FIG. 2, the coil 51 is placed so as to face the lateral surface of the lens barrel 12. The coil 51 is formed into a ring-like shape so that wires are located on the upper side and the lower side in FIG. 2 (that is, on the upper side and the lower side in the lower view of FIG. 1).

The yoke 52 is placed outside the coil 51. The yoke 52 focuses a magnetic flux produced by the magnet 53. The yoke 52 is made of, for example, a soft magnetic material such as iron with few impurities and is fixed on, for example, the housing 33.

The yoke 52 is placed so that a head part (a thickened part) of its T-shaped form is directed to the other yoke 52. For example, the yoke 52a is placed so that a head part of its T-shaped form is directed to the yoke 52b. Likewise, the yoke 52b is placed so that a head part of its T-shaped form is directed to the yoke 52a. In other words, the head part of the yoke 52b is arranged on the left side in the upper view of FIG. 1, and the head part of the yoke 52a is arranged on the lower side in the upper view of FIG. 1. It can also be said that the yoke 52 has the head part on a side where a guide mechanism to be described later exists.

The yoke 52a and the yoke 52b in this exemplary embodiment are different in thickness of long and thin leg parts formed below the head parts of the T-shaped forms. For example, the upper view of FIG. 3 shows an example of the yoke 52a, and the lower view of FIG. 3 shows an example of the yoke 52b. With reference to FIG. 3, the long and thin leg part of the yoke 52a is thinner than that of the yoke 52b.

Further, the magnet 53 is placed opposite the coil 51, in the vicinity of the lateral surface of the lens barrel 12. The magnet 53 is magnetized so that the upper part of a face opposite the lens barrel 12 is the N pole and the lower part is the S pole.

The voice coil motor has the configuration as described above, for example. Herein, electric power is supplied to the coil 51 by wires 34 installed on the four corners of the housing 33 and springs (not shown in the drawings) connected to the wires, and so on.

Applying electric current to the coil 51 causes the voice coil motor having the configuration as described above to produce a drive force for moving the lens barrel 12 along the direction of the optical axis of the lens 11. That is, when electric current is applied to the coil 51, because of the direction of the electric current and magnetic fluxes shown with curved arrows passing through the coil 51 from the magnet 53, the lens barrel 12 can move upward or downward (directions of an arrow Y1) on the surface of paper in accordance with the Fleming's left-hand rule. Thus, the voice coil motors cause the lens barrel 12 to reciprocate along the direction of the optical axis of the lens 11.

The configuration of the voice coil motor described above stabilizes the position of the lens barrel 12 as described below. Magnetic fluxes passing through the yoke 52 from the magnet 53 are produced. The yoke 52 has a property of seeking to take the magnetic fluxes from the magnet 53 as much as possible. Therefore, the yoke 52 acts so as to be located opposite the center of the magnet 53, that is, opposite the boundary of the N pole and the S pole. With such magnetic levitation, the lens barrel 12 connected with the magnet 53 levitates so that the yoke 52 is located at the boundary of the N pole and the S pole. Moreover, when the lens barrel 12 connected with the magnet 53 moves in accordance with the Fleming's left-hand rule and the yoke 52 is thereby dislocated upward or downward with respect to the center of the magnet 53, a magnetic spring effect, which is trying to turn back to the original position with a magnetic force, arises.

Thus, the lens barrel 12 connected with the magnet 53 is stably located in a position corresponding to a position where the yoke 52 is installed. Therefore, for example, by setting a position of the lens barrel 12 due to magnetic levitation to a predetermined position such as a focus position, which is frequently used, it is possible to limit driving of the lens barrel 12 by the voice coil motors described above, and it is possible to achieve power saving. In other words, use of the voice coil motors described above enables control of the position of the lens barrel 12 with respect to the housing 33 or the like even when a position detection unit 68 to be described later is not used or even in an open loop controller that does not use electric current feedback.

Further, the lens drive unit includes, as the configuration realizing the autofocus function, a guide mechanism (a guide part) that guides reciprocation of the lens barrel 12 along the optical axis as described above. The guide mechanism is placed in the middle position between the two neighboring voice coil motors around the lens barrel 12. That is, as shown in the upper view of FIG. 1, the lens drive unit includes the guide mechanism on an extended line C3 of a diameter dividing into two between the dashed-dotted lines C1 and C2, which are the two diameters passing through the center of the lens 11 and oing at right angles. Moreover, the lens drive unit includes a second guide mechanism on the extended line C3 of the dividing diameter, on the opposite side from the guide mechanism across the lens barrel 12. In other words, the guide mechanism and the second guide mechanism are installed diagonally on the housing 33 having a rectangular shape.

The abovementioned guide mechanism includes a guide ball retainer 62 installed on the lens barrel 12, a guide ball support 63 installed on the housing 33, and a guide ball 61 sandwiched by the guide ball retainer 62 and the guide ball support 63. For example, the guide mechanism includes two guide balls 61 which are the same in size and placed along a direction vertical to the surface of paper in the upper view of FIG. 1. The number of the guide balls 61 included by the guide mechanism may be one, or may be three or more.

The guide ball retainer 62 retains the guide ball 61 in a rotatable manner. The guide ball support 63 has a groove along the optical axis of the lens 11 as a range where the guide ball 61 can move. Consequently, the guide ball 61 rotates and moves in the groove formed on the guide ball support 63 and, with this, the lens barrel 12 on which the guide ball retainer 62 is installed can move only in a direction along the groove formed on the guide ball support 63.

Further, as described above, the lens drive unit includes the second guide mechanism. The second guide mechanism is a mechanism as a pair with the abovementioned guide mechanism. The second guide mechanism is placed on the opposite side from the guide mechanism across the lens barrel 12 around the lens barrel 12.

The second guide mechanism includes a retaining member 66 installed on the lens barrel 12, a guide ball support 67 formed on the housing 33, and a guide ball 65 sandwiched by the retaining member 66 and the guide ball support 67. As well as the guide mechanism described above, the second guide mechanism includes, for example, two guide balls 65 which are the same in size and placed along a direction vertical to the surface of paper in the upper view of FIG. 1. The number of the guide balls 65 included by the guide mechanism may be one, or may be three or more.

The retaining member 66 retains the guide balls 65 in a rotatable manner. For example, by sandwiching the guide balls 65 with a U-shaped sandwiching part, the retaining member 66 retains the guide balls 65 in a rotatable manner. The guide ball support 67 is a wall against which the guide balls 65 are pressed by the retaining member 66. As described before, the guide ball support 67 is formed on the housing 33.

As shown in FIG. 1, the retaining member 66 retains the guide balls 65 from one side with respect to the dashed-dotted line C3, which is a line passing through the center of the lens 11 and connecting the guide mechanism with the second guide mechanism. As described later, the retaining member 66 presses the guide balls 65 against the guide ball support 67 installed on the other side with respect to the dashed-dotted line C3. The guide ball support 67 may have a groove along the optical axis of the lens 11 as a range where the guide balls 65 can move. Thus, in the second guide mechanism, the retaining member 66 sandwiches the guide balls 65 from one side of the guide balls 65. Moreover, the guide ball support 67 is located on the other side of the guide balls 65.

Further, a position detection unit 68 that detects the position of the lens barrel 12 can be installed on the lens drive unit (the housing 33). The position detection unit 68 is formed by, for example, a hole element that detects the strength of a magnetic field. With the position detection unit 68, it is possible to detect the position of the lens barrel 12.

The above is a description of an example of the configuration of the camera module 1.

As described above, in this exemplary embodiment, the yoke 52 fixed on the housing 33 and the magnet 53 are used. With such a configuration, the magnet 53 is attracted to the yoke 52 by a magnetic force which attracts the magnet 53 and the yoke 52 to each other, and consequently, the lens barrel 12 on which the magnet 53 is placed is attracted to the housing 33. That is, a force (a magnetic force) in an arrow Y4 direction obtained by combining a force in arrow Y2 direction with a force in an arrow Y3 direction in FIG. 4 is applied to the lens barrel 12. Moreover, in this exemplary embodiment, as described above, the T-shaped yokes 52 are used, and the yokes 52 are placed so that the head part of the T-shaped form of one yoke 52 is directed to the other. Such a configuration allows for making the magnetic flux density on the side where the other yoke 52 is placed higher than the magnetic flux density on the side where the other yoke 52 is not placed. In other words, for example, in the case shown in FIGS. 1 and 4, use of the yoke 52b allows for making the magnetic flux density on the left side of the yoke 52b higher than on the right side. Consequently, it is possible to more efficiently strengthen the force in the arrow Y4 direction. In other words, the configuration in this exemplary embodiment can efficiently realize a state where the lens barrel 12 is pressed against the guide balls 61. As a result, when the lens barrel 12 moves along the optical axis direction, the lens barrel 12 remains pressed against and supported by the guide balls 61, so that it is possible to realize stable movement without instability of the optical axis.

Further, as described above, the long and thin leg part of the yoke 52b is thicker than that of the yoke 52a. This makes the magnetic flux density of the voice coil motor including the yoke 52b higher than that of the voice coil motor including the yoke 52a. As a result, a magnetic force by which the yoke 52b is attracted to the magnet 53b is stronger than a magnetic force by which the yoke 52a is attracted to the magnet 53a, and a force in an arrow Y5 direction in FIG. 4 is applied to the lens barrel 12. This causes the retaining member 66 to press the guide balls 65 against the guide ball support 67, so that it is possible to realize stable movement without instability of the optical axis.

The configuration of the guide mechanism described above will be described in detail. As shown in FIG. 5, the guide ball retainer 62 is a spherical retainer having an opening, and its inner face holding a half or more of the guide ball 61 is a little larger than a hemisphere. Near the opening, the inner face of the guide ball retainer 62 has almost the same shape and size as the guide ball 61, and the guide ball retainer 62 contacts and retains the guide ball 61 in a rotatable manner in the vicinity of the opening. On the other hand, near the innermost part, the internal face is formed larger than the outline of the guide ball 61, and there is a space 62a between the guide ball retainer 62 and the guide ball 61 retained thereby. The guide ball retainer 62 in this exemplary embodiment retains the guide ball 61 with the space 62a from the guide ball 61 located on the line connecting the guide ball 61 and the center of the lens 11 (i.e., on the dashed-dotted line C3) particularly as shown in the upper view of FIG. 5.

Thus, the guide ball retainer 62 in this exemplary embodiment retains the guide ball 61 only in the vicinity of a circle of a sphere intersecting with a plane passing near the center of the guide ball 61. Consequently, a load radius is small, so that it is possible to make the movement resistance of the lens barrel 12 low. Moreover, because there is a space between the guide ball retainer 62 and the guide ball 61, it is possible to inhibit increase of a load resistance due to wear debris or the like.

Further, the guide ball support 63 of the guide mechanism has the groove 63a holding part of the guide ball 61 along the optical axis direction, and the guide ball 61 is retained by the groove so as not to move off the optical axis direction. The shape of the groove 63a of the guide ball support 63 is like an arc which contacts part of the spherical surface of the guide ball 61 as shown in the upper view of FIG. 5, for example. However, the shape of the groove 63a of the guide ball support 63 is not limited to such a shape and, as shown in the upper view of FIG. 5, the groove may be formed by a plurality of surfaces formed to contact part of the spherical surface of the guide ball 61 at a plurality of points.

Thus, in the camera module 1 of this exemplary embodiment, the lens barrel 12 can be pressed against the guide balls 61. Moreover, the guide balls 65 can be pressed against the guide ball support 67 by the retaining member 66. Consequently, the stability of the lens barrel 12 at the time of movement can be increased. That is, according to this exemplary embodiment, the yokes 52 are arranged so as to press the lens barrel 12 against the guide mechanism by a magnetic force by which the yokes 52 and the magnets 53 are attracted to each other, so that the stability of the lens barrel 12 at the time of movement can be increased.

According to the present invention, the number and arrangement of the voice coil motors or the number and arrangement of the guide mechanisms (the guide balls) and the second guide mechanisms are not limited to those described above. Moreover, the shape of the yoke 52 is not limited to that described above.

For example, as shown in FIG. 6, the yoke 52 may be formed into a rod-like shape or the like. With reference to the upper view and the lower view of FIG. 6, the rod-like yoke 52 is placed on a side close to the other yoke 52 (i.e., in the position where the head part of the abovementioned T-shaped yoke 52 lies). Such a configuration can also increase the force in the arrow Y4 direction in FIG. 4. Moreover, as a shape that a part on a side close to the guide mechanism is larger in cross section area than a part on a side far from the guide mechanism, the yoke 52 may be formed into a shape other than the T shape. For example, the yoke 52 may be formed into a triangular shape or the like.

Further, as for the yokes 52, the yoke 52a and the yoke 52b may be formed into plates with different thicknesses. Thus, the yoke 52a and the yoke 52b may be formed into a shape other than the shape illustrated in this exemplary embodiment, which is a shape that a magnetic force by which the yoke 52a is attracted to the magnet 53a is different from a magnetic force by which the yoke 52b is attracted to the magnet 53b.

Thus, the shape of the yoke 52 is not necessarily limited to a T-shaped form. Moreover, by controlling the magnets 53 instead of controlling the shape or the like of the yokes 52 or in addition to controlling the shape of the yokes 52, the yokes 52 may be configured so that a magnetic force by which the yoke 52a is attracted to the magnet 53a is different from a magnetic force by which the yoke 52b is attracted to the magnet 53b.

Further, for example, as shown in FIG. 7, the voice coil motors may be arranged around the lens barrel 12, on the opposite sides from each other across the lens barrel 12. That is, as shown in FIG. 7, two voice coil motors may be arranged across the lens barrel 12 on an extended line of a predetermined diameter of the lens 11 (i.e., on the dashed-dotted line C1). In other words, the voice coil motors can be arranged in the middles of the opposite side walls of the rectangular housing 33, respectively.

In this case, the head parts of the Y-shaped yokes 52 are arranged in the same direction to press the lens barrel 12 (a direction where the guide mechanism is installed). For example, in the case shown in FIG. 7, the yokes 52 are arranged so that the head parts of the yokes 52 are located toward the lower side in FIG. 7. Also with such a configuration, it is possible to keep the lens barrel 12 pressed against the guide balls 61, so that it is possible to realize stable movement without instability of the optical axis.

Further, in the case shown in FIG. 7, the guide mechanism is placed in the middle position of the two voice coil motors around the lens barrel 12, for example. That is, as shown in FIG. 7, in a case where the two voice coil motors are arranged on the dashed-dotted line C1, the guide mechanism is placed on an extended line (the dashed-dotted line C2) of a diameter orthogonal to the diameter (the dashed-dotted line C1). In other words, the guide mechanism can be placed in the middle of a side wall sandwiched by the opposite side walls of the housing 33 where the two voice coil motors are arranged, respectively.

Further, the second guide mechanism is placed on the opposite side from the guide mechanism across the lens barrel 12 around the lens barrel 12. That is, the second guide mechanism can be placed in the middle of a side wall where the guide mechanism is not placed of the side walls sandwiched by the opposite side walls of the housing 33 where the two voice coil motors are placed, respectively.

Furthermore, in the case shown in FIG. 7, as the second guide mechanism, a cylindrical or spherical fixed member 71 installed on the housing 33 and a U-shaped sandwiching member 72 installed on the lens barrel 12 can be employed. The U-shaped sandwiching member 72 is placed while sandwiching the fixed member 71 in the open space of the U-shaped part. Because the open space of the U-shaped part of the sandwiching member 72 has a predetermined length in depth, the fixed member 71 can move inside the open space. That is, in the case shown in FIG. 7, the sandwiching member 72 can move with respect to the fixed member 71 only in a direction along a line connecting the guide mechanism with the second guide mechanism (i.e., on the dashed-dotted line C2), and consequently, the lens barrel 12 can move along the line (the dashed-dotted line C2). Thus, with a space between the U-shaped sandwiching member 72 and the fixed member 71, it is possible to appropriately control a situation that the lens barrel 12 is pressed against the guide balls 61, and it is possible to realize stable support and movement.

In this exemplary embodiment, a case where the lens barrel 12 has the magnet 53 and the housing 33 has the coil 51 and the yoke 52 has been described. However, for example, the camera module may be configured so that the lens barrel 12 has the coil 51 and the yoke 52 and the housing 33 has the magnet 53.

### Second Exemplary Embodiment

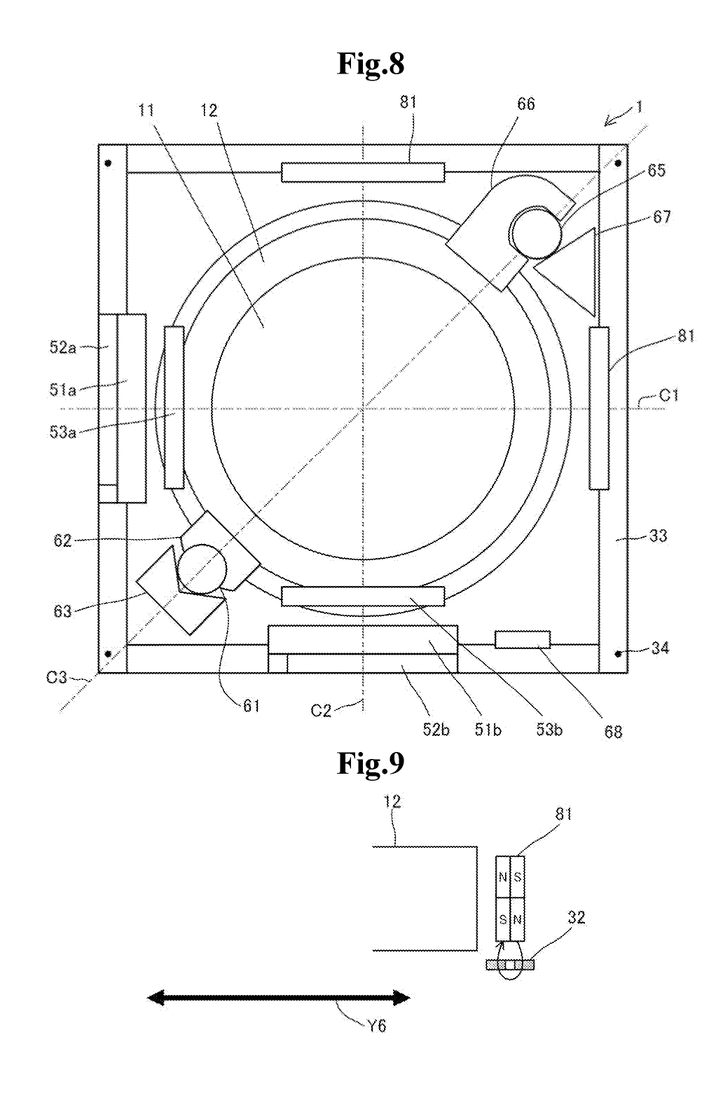

Next, a second exemplary embodiment of the present invention will be described with reference to FIGS. 8 and 9. FIG. 8 is a view showing a configuration of the camera module 1 in this exemplary embodiment. FIG. 9 is a view showing an operation of the lens drive unit.

As shown in FIG. 8, the lens drive unit of the camera module 1 in this exemplary embodiment includes, in addition to the configurations described in the first exemplary embodiment, an OIS (Optical Image Stabilizer) magnet 81 as a configuration realizing a stabilizer function.

With reference to FIG. 8, the OIS magnets 81 are installed on the dashed-dotted line C1 on the opposite side from the voice coil motor (the coil Ma) across the lens barrel 12, and on the dashed-dotted line C2 on the opposite side from the voice coil motor (the coil 51b) across the lens barrel 12.

As shown in FIG. 9, each of the OIS magnets 81 is magnetized so that a face opposite the FP coil 32 is an N pole and an S pole. A coil is formed at a part of the FP coil 32 opposite each of the OIS magnets 81. Consequently, when electric current is applied to the coil, because of a magnetic flux produced by the OIS magnet 81 and the electric current, it is possible to move the housing 33, that is, the lens barrel 12 in an arrow Y6 direction (i.e., along the surface of paper of the upper view of FIG. 1) in accordance with the Fleming's left-hand rule. Thus, it is possible to realize the stabilizer function with a simple configuration.

### Third Exemplary Embodiment

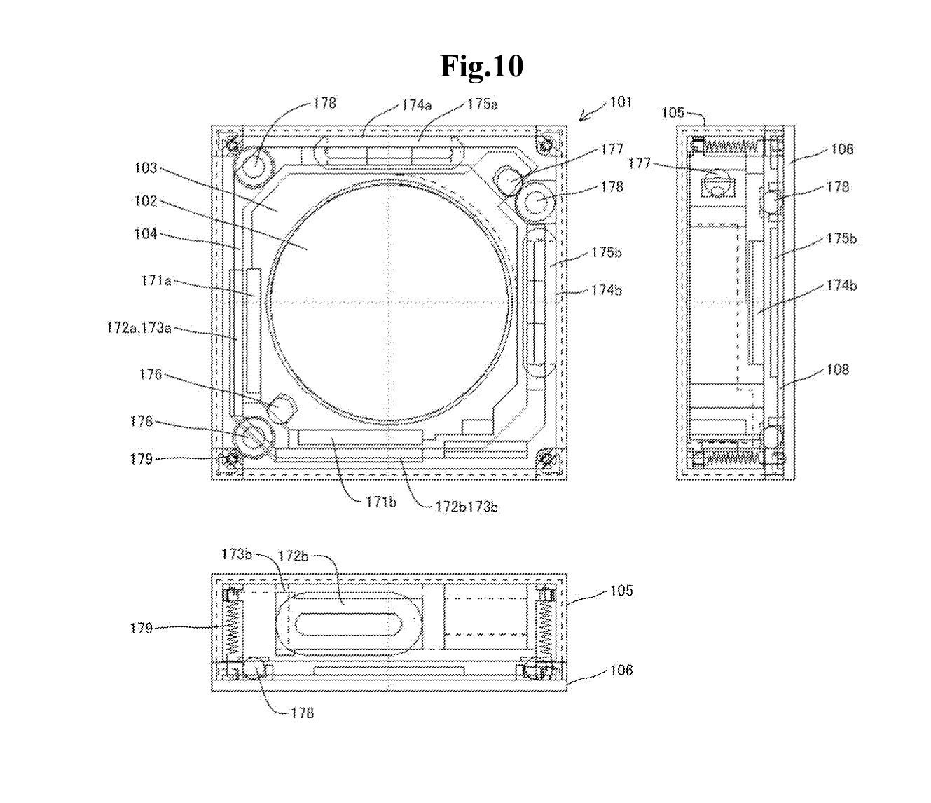

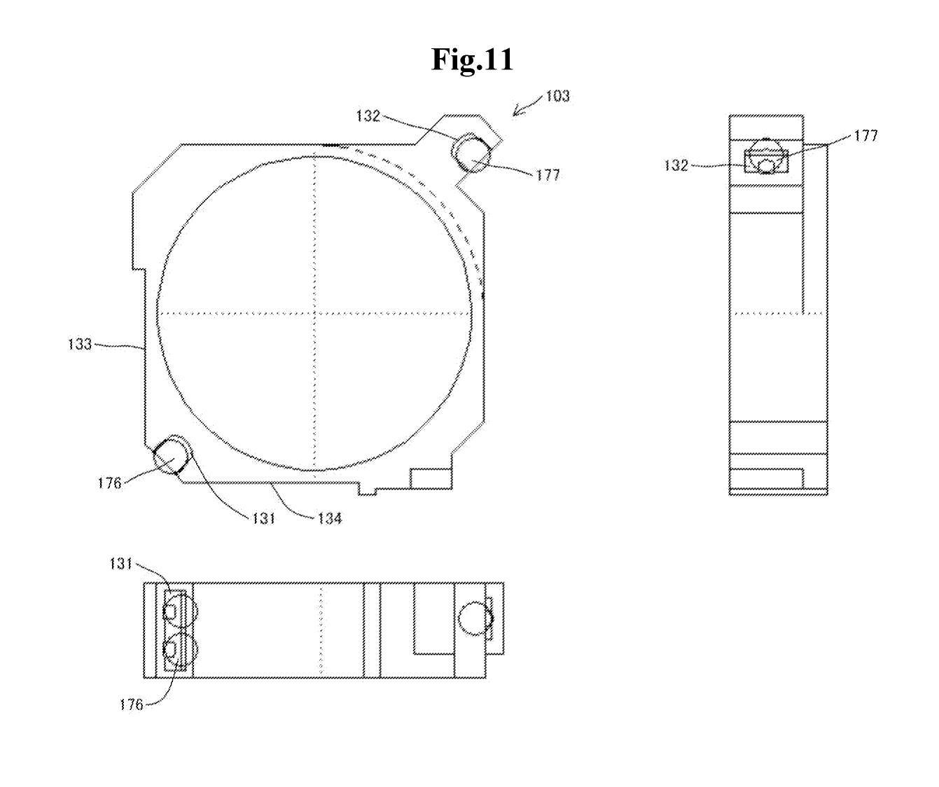

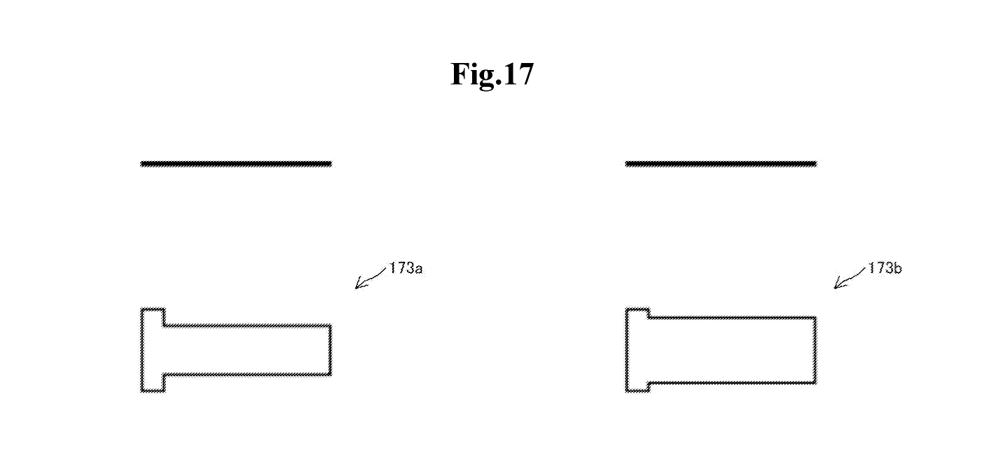

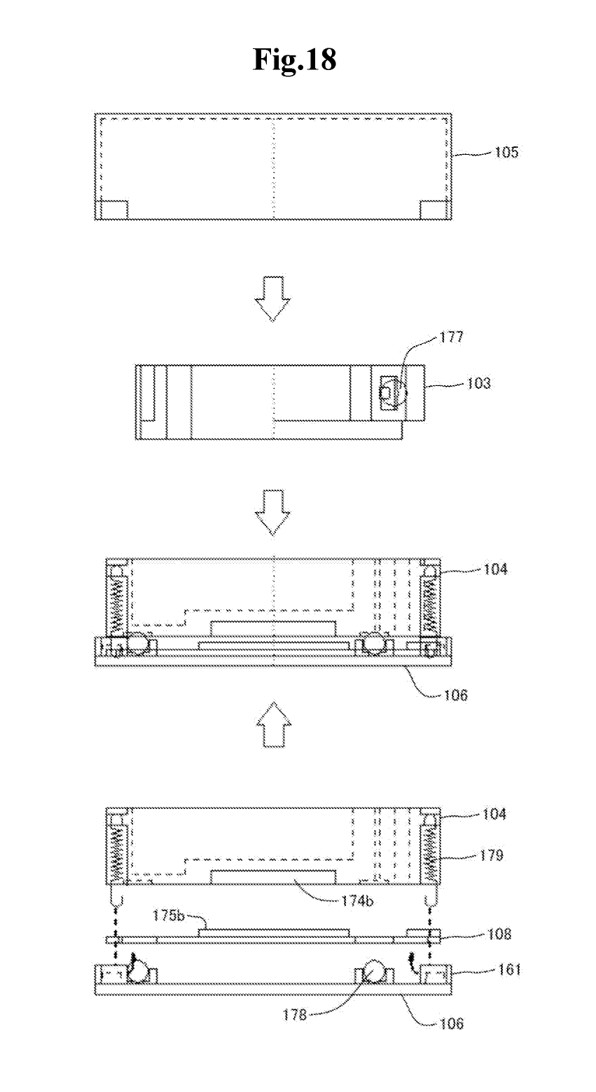

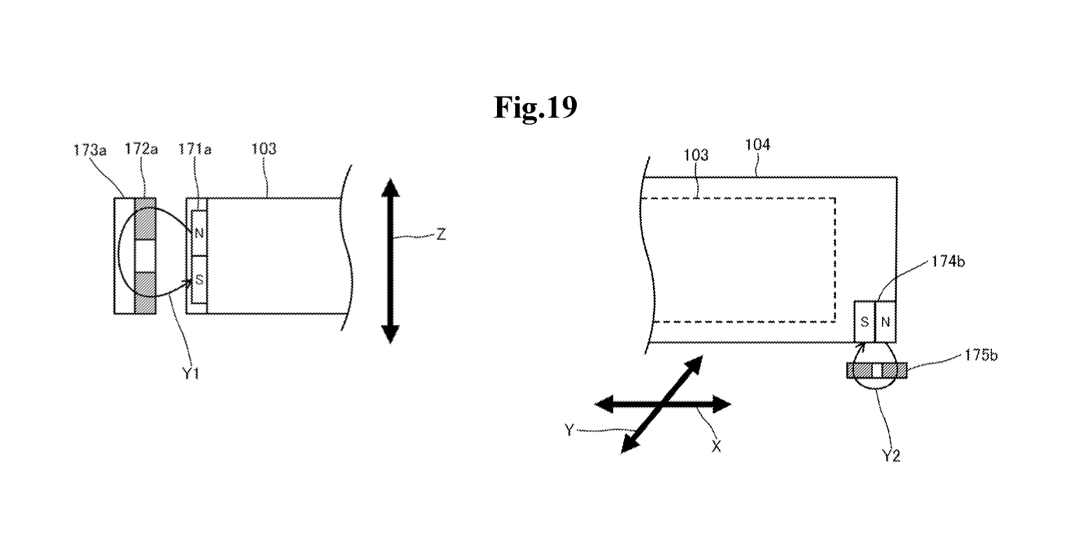

A third exemplary embodiment of the present invention will be described with reference to FIGS. 10 to 19. FIG. 10 is a view showing a configuration of a camera module 101. FIGS. 11 to 16 are views showing components included by the camera module. FIG. 17 is a view showing how the camera module is assembled. FIGS. 18 to 19 are views showing an operation of the camera module.

The camera module 101 according to the present invention is, for example, for taking an image, mounted on an information processing terminal such as a smartphone and a tablet terminal. However, the camera module 101 according to the present invention is not necessarily limited to being mounted on an information processing terminal. The camera module 101 may be mounted on other electronic equipment or various types of equipment.

The camera module 101 according to the present invention includes a lens drive unit which has an autofocus function and a stabilizer function; the autofocus function automatically focuses at the time of taking an image of an object, and the stabilizer function optically compensates for camera shake occurring at the time of taking an image to reduce blur of the image. Hereinafter, a configuration of the lens drive unit for realizing the autofocus function and the stabilizer function will be mainly described. Meanwhile, the lens drive unit may have a function other than the functions illustrated in this exemplary embodiment.

### [Configuration]

First, the overall configuration of the camera module 101 will be described with reference to FIG. 10. FIG. 10 shows a plan view and side views of the camera module 101. In the drawings of this application, the configuration is partly made to be transparent or omitted for the purpose of clarifying the structure.

First, the camera module 101 includes a cover 105 which covers the top and a bottom cover 106 which covers the bottom. In FIG. 10, the top face and side faces of the cover 105 are illustrated in a perspective manner so as to be transparent. The camera module 101 includes a lens barrel 103 equipped with a lens 102, and a housing 104 surrounding the lens barrel 103 and housing the lens barrel 103, inside the cover 105 and the bottom cover 106 (a support cover). In addition, the camera module 101 includes two first voice coil motors 171-173 that move the lens barrel 103 along the direction of the optical axis of the lens 102 with respect to the housing 104, and two first guide parts 176 and 177 that guide movement of the lens barrel 103 with respect to the housing 104. Mainly, by the first voice coil motors 171-173 and the first guide parts 176 and 177, the autofocus function of the lens 102 is realized.

Further, the housing 104 is supported by the bottom cover 106 on the bottom face side (one face side) of the lens 102, and the camera module 101 includes second voice coil motors 174-175 which move the housing 104 in a vertical direction to the direction of the optical axis of the lens 102 with respect to the bottom cover 106. In addition, the camera module 101 includes second guide parts 178 that are placed between the housing 104 and the bottom cover 106 to guide movement of the housing 104 with respect to the second voice coil motors 174-75, and connection springs 79 (connection members) that connect the housing 104 to the bottom cover 106. Mainly by these components, the stabilizer function of the lens 102 is realized.

Further, the camera module 101 includes a FPC (Flexible Printed Circuit) 108, and other components. Hereafter, the respective components will be described.

With reference to FIG. 11, the configuration of the lens barrel 103 will be described. FIG. 11 shows a plan view and side views of the lens barrel 103. The lens barrel 103 has a substantially rectangular outline. At the center of the lens barrel 103, a lens housing hole that houses the lens 102 is formed.

Further, concave parts 133 and 134 that are dented inward are formed on side faces of the lens barrel 103. To be specific, the concave parts 133 and 134 are formed on, of the side faces of the lens barrel 103, two side faces corresponding to two neighboring sides of the substantially rectangular outline, closer to a corner at the intersection of the two sides, respectively. In the concave parts 133 and 134, magnets 171a and 171b configuring the first voice coil motors are placed, respectively. The first voice coil motors move the lens barrel 103 along the direction of the optical axis of the lens 102, and are configured by the magnets 171a and 171b, and coils 172a and 172b and yokes 173a and 173b that are arranged on the housing 104 so as to be opposite the magnets 171a and 171b (as described later), respectively. Thus, the first voice coil motors that realize the autofocus function are arranged on the two side faces corresponding to the two neighboring sides of the substantially rectangular outline.

Further, a first guide ball retaining part 131 is formed at a corner sandwiched by the two neighboring sides of the substantially rectangular lens barrel 103 on which the two first voice coil motors are placed. The first guide ball retaining part 131 is formed by a groove along the direction of the optical axis of the lens 102, and the groove is open outward on a diagonal line that passes the corner with the groove formed. Then, the first guide ball retaining part 131 retains a spherical main guide ball 176 (a main guide part) as part of the first guide part, in a rotatable manner. The main guide ball 176 is pressed against and supported by a first guide ball support part 141 formed on the inner surface of the housing 104 to be described later. Consequently, the main guide ball 176 rotates in the groove serving as the first guide ball retaining part 131 and, with this, the lens barrel 103 is guided by the main guide ball 176 to move along the direction of the optical axis of the lens 102. In FIG. 11, two main guide balls 176 are retained in the groove serving as the guide ball retaining part 131, but any number of main guide balls 176 may be retained.

Further, on the lens barrel 103, a second guide ball retaining part 132 is formed at the other corner located diagonally to the corner where the first guide ball retaining part 131 is formed. The second guide ball retaining part 132 is formed into a substantially spherical hole, and the hole is open in a direction orthogonal to the diagonal line that passes the corner with the hole formed. The second guide ball retaining part 132 retains a spherical sub guide ball 177 (a sub guide part), which is part of the first guide part, in a rotatable manner. The sub guide ball 177 is pressed against and supported by a second guide ball support part 142 formed on the inner face of the housing 104 to be described later. Consequently, the sub guide ball 177 rotates in the hole serving as the second guide ball retaining part 132 and, with this, the lens barrel 103 moves along the direction of the optical axis of the lens 102.

Further, the lens barrel 103 may include a position detection mechanism that detects the position of the lens barrel 103 along the direction of the optical axis of the lens 102. The position detection mechanism includes, for example, a magnet and a hole element that detects the strength of a magnetic field, and may be configured so that the magnet is placed on the lens barrel 103 and the hole element is placed on the housing 104 to be described later.

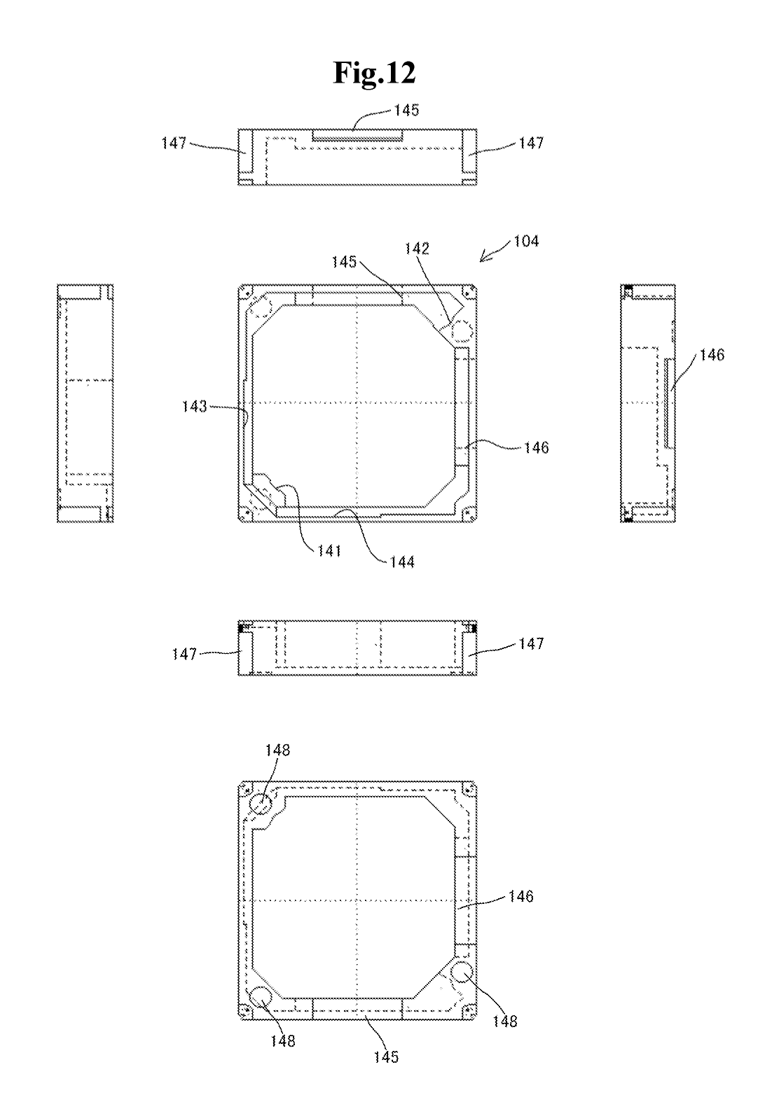

Next, with reference to FIG. 12, the configuration of the housing 104 will be described. FIG. 12 shows a plan view, side views and a bottom view of the housing 104.

The housing 104 is a tubular member formed by four side walls and having a substantially rectangular end face. Inside the housing 104, the lens barrel 103 equipped with the lens 102 is housed, and the components configuring the first voice coil motors are included. Moreover, the housing 104 is equipped with components configuring the second voice coil motors to be described later.

To be specific, the first guide ball support part 141 that has a concave shape and receives the main guide ball 176 is formed on the inner surface at one corner of the housing 104, that is, on the inner surface at a corner corresponding to the first guide ball retaining part 131 formed on the lens barrel 103 housed in the housing 104. Moreover, the second guide ball support part 142 that has a concave shape and receives the sub guide ball 177 is formed on the inner surface at the other corner located diagonally to the one corner, that is, on the inner surface at a corner corresponding to the second guide ball retaining part 132 formed on the lens barrel 103 housed in the housing 104.

Further, on two of the side walls of the housing 104, first concave parts 143 and 144 are formed by forming the inner surfaces of the side walls themselves into concave shapes, respectively. To be specific, the first concave parts 143 and 144 are formed, respectively, at positions opposite the magnets 171a and 171b mounted on the lens barrel 103 housed inside the housing 104 on the side walls of the housing 104. The coils 172a and 172b and the yokes 173a and 173b configuring the first voice coil motors, respectively, are arranged in the first concave parts 143 and 144, respectively.

Further, the bottom faces of the side walls of the housing 104 are dented upward as second concave parts 145 and 146. To be specific, the second concave parts 145 and 146 are formed, respectively, on the bottom faces on, of the side walls of the housing 104, side walls corresponding to two neighboring sides of the substantially rectangular outline where either the first concave part 143 or 144 is not formed. Then, magnets 174a and 174b configuring the second voice coil motors are arranged in the second concave parts 145 and 146, respectively. The second voice coil motors allow movement of the housing 104 that houses the lens barrel 103 along a vertical plane to the direction of the optical axis of the lens 102, and include the magnets 174a and 174b, and coils 175a and 175b placed on the bottom cover 106 as described later, respectively. Then, one of the second voice coil motors including the magnet 174b shown in FIG. 10 moves the housing 104 along one linear direction (an X-axis direction) on the vertical plane to the direction of the optical axis of the lens 102. Moreover, the other second voice coil motor including the magnet 174a moves the housing 104 along another linear direction (a Y-axis direction) orthogonal to the one linear direction on the vertical plane to the direction of the optical axis of the lens 102.

Further, at the four corners on the bottom face of the housing 104, cutout parts 147 cut toward the top face are formed. In the four cutout parts 147, connection springs 179 are housed, respectively. Therefore, the inner face of the ceiling of each of the cutout parts 147 is formed so that one end of the connection spring 179 gets caught.

Moreover, support guide ball receiving parts 148 formed into concave shapes to receive support guide balls 178 to be described later are formed at three places on the bottom surface of the housing 104.

Further, the housing 104 may include part of a position detection mechanism that detects the position of the lens barrel 103 along the direction of the optical axis of the lens 102. The position detection mechanism includes, for example, a magnet and a hole element that detects the strength of a magnetic field, and the hole element that detects the strength of the magnetic field of the magnet placed on the lens barrel 103 may be placed on the housing 104. Moreover, the housing 104 may include a position detection mechanism that detects the position of the housing 104 in a direction vertical to the optical axis direction of the lens 102, that is, the position with respect to the bottom cover 106. For example, the position detection mechanism may be configured so that the magnet is placed on the housing 104 and the hole element is placed on the bottom cover 106.

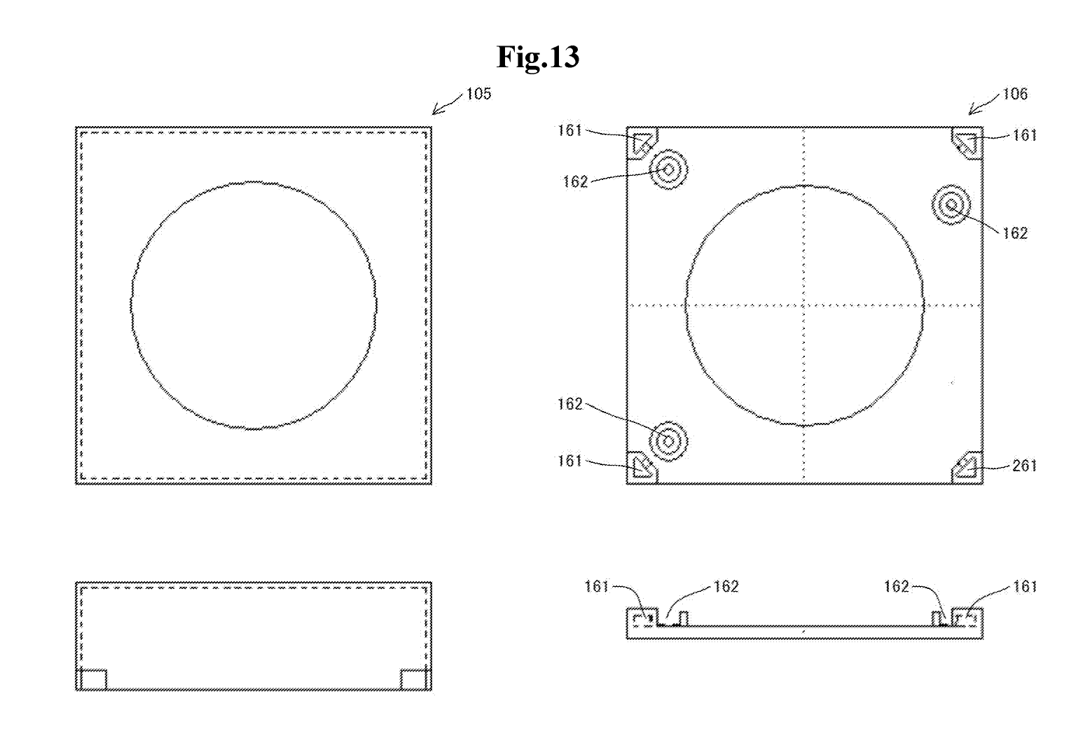

Next, with reference to FIG. 13, configurations of the cover 105 and the bottom cover 106 will be described. A left view of FIG. 13 shows a plan view and a side view of the cover 105, and a right view of FIG. 13 shows a plan view and a side view of the bottom cover 106.

The cover 105 has a top face formed into a substantially rectangular shape, and is formed into a box-like shape whose four sides are surrounded by side walls. Then, the housing 104 and so on described above are covered from above. At the center of the top surface of the cover 105, a hole having a size corresponding to the size of the lens 102 is formed.

The bottom cover 106 is a plate-like member formed into a substantially rectangular shape, and covers the bottom face of the housing 104 and so on covered with the cover 105. A hole having a size corresponding to the size of the lens 102 is formed at the center of the bottom cover 106. Moreover, at each of the four corners of the bottom cover 106, a catching part 161 that catches the other end of the abovementioned connection spring 179 is formed. Moreover, three housing parts 162 are formed on the bottom cover 106. Each of the housing parts 162 houses the spherical support guide ball 178 in a rotatable manner, and specifies the position of the support guide ball 178. The support guide ball 178 has a function to, while being kept sandwiched between the support guide ball receiving part 148 formed on the housing 104 and the bottom cover 106, guide the housing 104 so as to move on a vertical plane to the direction of the optical axis of the lens 102 with respect to the bottom cover 106. The number of the housing parts 162 is not limited to three, so that the number of the support guide balls 178 is not limited to three, either.

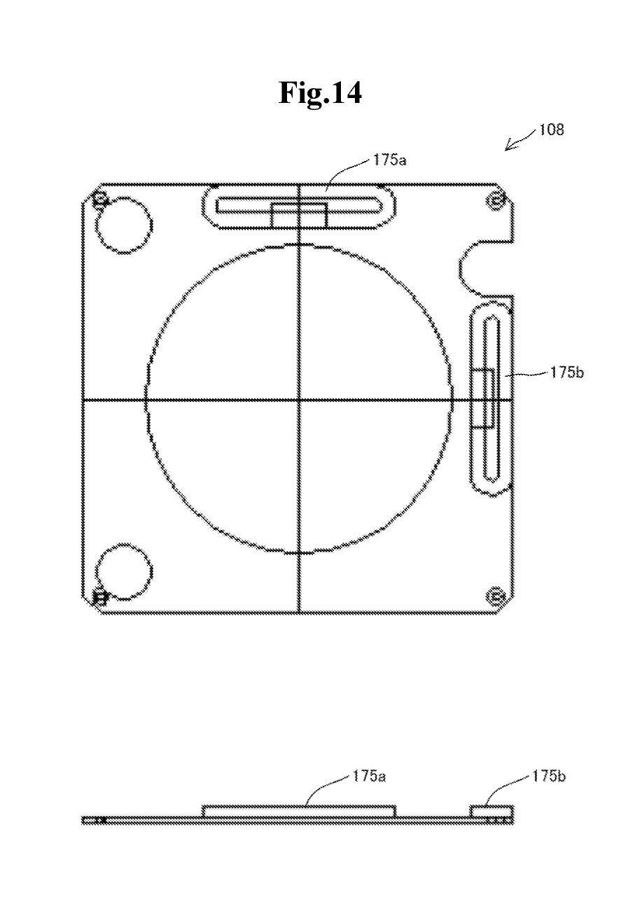

Next, with reference to FIG. 14, the configuration of the FPC will be described. FIG. 14 shows a plan view and a side view of the FPC 108.

The FPC 108 has a thin plate-like shape, and the outline thereof is almost the same as the bottom cover 106. Therefore, the FPC 108 is assembled almost integrally with the bottom cover 106, and can be treated as the same member as the bottom cover 106. The coils 175a and 175b included by the second voice coil motors, respectively, are formed on two neighboring sides of the FPC 108, respectively. To be specific, the coils 175a and 175b are installed opposite the magnets 174a and 174b included by the second voice coil motors installed on the housing 104.

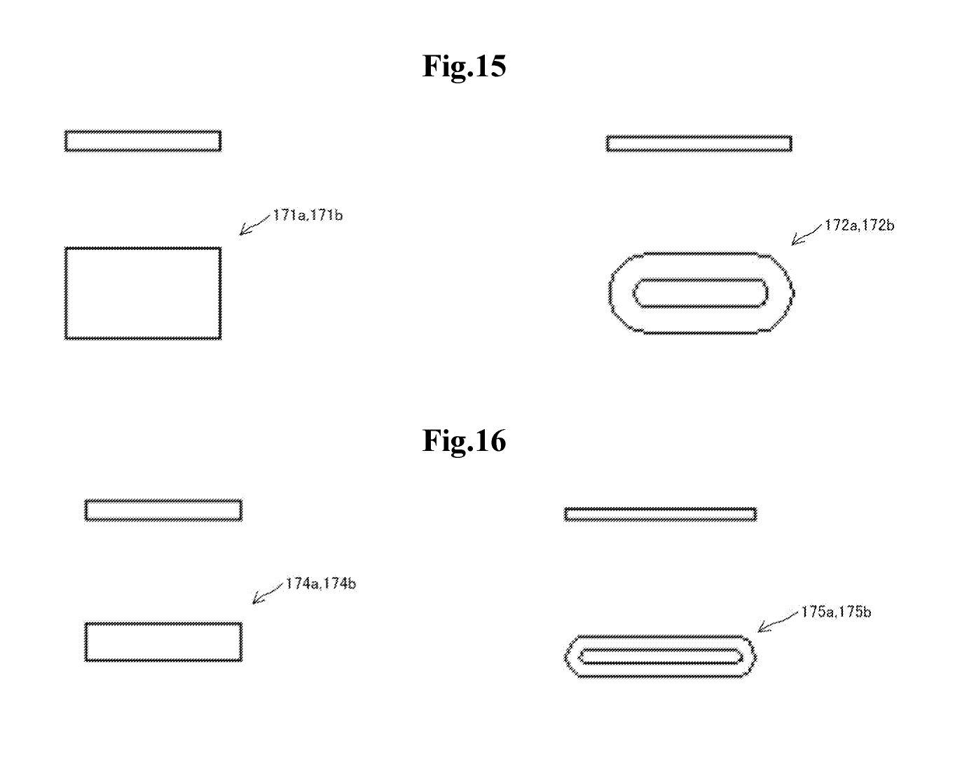

Next, with reference to FIGS. 15 to 17, the components for the first voice coil motors and the second voice coil motors will be described. The first voice coil motors include the magnets 171a and 171b placed on the lens barrel 103, and the coils 172a and 172b and the yokes 173a and 173b placed on the housing 104, respectively.

As shown in a front view and a plan view in the left view of FIG. 15, the magnets 171a and 171b included by the first voice coil motors are each formed into a rectangular shape having a predetermined thickness. Moreover, as shown in a front view and a plan view in the right view of FIG. 15, the coils 172a and 172b included by the first voice coil motors have outlines of almost the same sizes as the magnets 171a and 171b, and are formed into oval ring-like shapes.

Further, as shown in a front view and a plan view in the left view and a right view of FIG. 17, the yokes 173a and 173b included by the first voice coil motors are formed into T-shaped thin plates, respectively, but the shapes are slightly different from each other. The first yoke 173a shown in the left view of FIG. 17 is placed so as to correspond to the magnet 171a and the coil 172a, and the second yoke 173b shown in the right view of FIG. 17 is placed so as to correspond to the magnet 171b and the coil 172b. As shown in the drawings, the second yoke 173b has a larger shape than the first yoke 173a. To be specific, the leg part of the T-shaped form of the second yoke 173b has a larger thickness than that of the first yoke 173a. The yokes 173a and 173b are placed so that the head parts of the T-shaped forms are placed closer to a corner at the intersection of the two neighboring sides of the lens barrel 103 where the yokes are placed.

Further, the second voice coil motors include the magnets 174a and 174b placed on the housing 104, and the coils 175a and 175b installed on the bottom cover 106, namely, on the FPC 108, respectively. As shown in a front view and a plan view in the left view of FIG. 16, the magnets 174a and 174b included by the second voice coil motors are each formed into a rectangular shape having a predetermined thickness. Moreover, as shown in a front view and a plan view in the right view of FIG. 16, the coils 175a and 175b included by the second voice coil motors each have an outline of almost the same size as the magnets 174a and 174b, and are each formed into an oval ring-like shape.

### [Assembly]

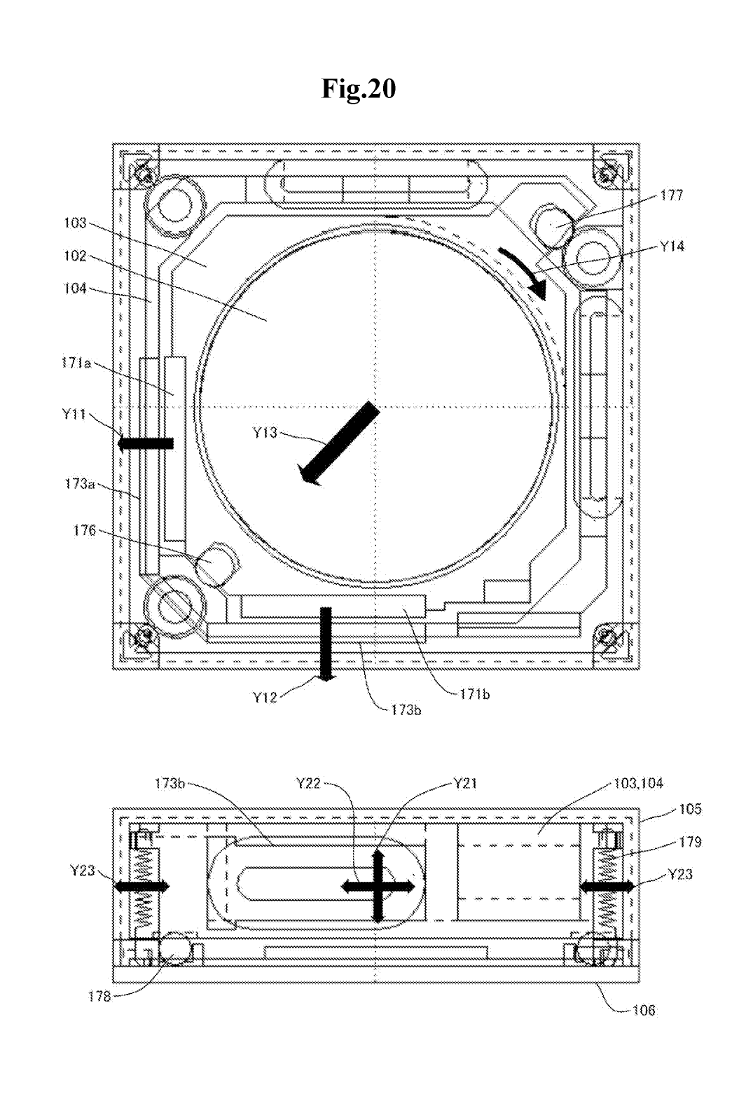

Next, how to assemble the camera module 101 described above will be described with reference to FIG. 18. In FIG. 18, the camera module 101 shown in FIGS. 10 and 20 is taken from the right side. In an assembly procedure to be described below, the order of processes may be varied.

First, with reference to a fourth view from the top in FIG. 18 (the fourth view), assembly of the housing 104 and the bottom cover 106 will be described. The housing 104 and the bottom cover 106 are connected via the connection springs 179 while sandwiching the FPC 108. To be specific, first, the four connection springs 179 are placed, respectively, in the cutout parts 147 formed on the bottom face side at the four corners of the housing 104, and one ends of the connection springs are caught on and connected to the ceiling faces of the cutout parts 147, respectively. Then, as shown by a dotted line arrow in the fourth view of FIG. 18, the other ends of the connection springs 179 are inserted into the holes formed at the four corners of the FPC 108, and are caught by and connected to the catching parts 161 formed at the four corners of the bottom cover 106

Then, the support guide balls 178 are arranged in the three housing parts 162 formed on a face of the bottom cover 106 facing the housing 104. Thus, the support guide balls 178 pass through the three through holes formed on the FPC 108 and come in contact with the housing 104 at the support guide ball receiving parts 148 formed on the bottom face of the housing 104. Consequently, the support guide balls 178 are placed while being sandwiched between the housing 104 and the bottom cover 106.

As a result that the housing 104, the FPC 108 and the bottom cover 106 are assembled in the above manner, a force pulling the housing 104 and the bottom cover 106 to each other with the support guide balls 178 therebetween is applied by the connection springs 179. Therefore, as shown in a third view from the top in FIG. 18 (the third view), the housing 104 and the bottom cover 106 are integrated into one body and kept connected at a distance for the diameter of the support guide ball 178 at all times.

Before the assembly, the coils 175a and 175b included by the second voice coil motors are placed on the FPC 108. In addition, the magnets 174a and 174b included by the second voice coil motors are placed opposite the coils 175a and 175b in the second concave parts 145 and 146 formed on the bottom face of the housing 104. Consequently, driving by the stabilizer function can be realized. Moreover, the coils 172a and 172b and the yokes 173a and 173b included by the first voice coil motors are placed, respectively, in the first concave parts 143 and 144 formed on the side walls of the housing 104.

Subsequently, the lens barrel 103 shown in a second view from the top in FIG. 18 (the second view) is housed in the housing 104. On the lens barrel 103, the lens 102 is mounted in a lens housing hole at the center. Moreover, in the concave parts 133 and 134 formed on the side faces of the lens barrel 103, the magnets 171a and 171b included by the first voice coil motors are placed, respectively. When the lens barrel 103 is housed into the housing 104, the magnets 171a and 171b are placed opposite the coils 172a and 172b and the yokes 173a and 173b included by the first voice coil motors placed on the housing 104, so that driving by the autofocus function can be realized.

Further, on the lens barrel 103, the main guide ball 176 is installed in the first guide ball retaining part 131, and the sub guide ball 177 is installed in the second guide ball retaining part 132. Then, when the lens barrel 103 is housed into the housing 104, the main guide ball 176 comes in contact with the first guide ball support part 141 of the housing 104 and is supported thereby, and the sub guide ball 177 comes in contact with the second guide ball support part 142 of the housing 104 and is supported thereby.

Meanwhile, components such as a magnet and a hole element configuring a position detection mechanism that detects the position of the lens barrel 103 along the direction of the optical axis of the lens 102 or the position of the housing 104 on a vertical plane to the optical axis direction, and other components that are not shown in the drawings may be installed during the abovementioned procedure.

Finally, the cover 105 shown in a first view on the top in FIG. 18 (the first view) is placed from above so as to cover the housing 104, whereby the assembly of the camera module 101 ends.

### [Operation]

Next, an operation of the camera module 101 will be described with reference to FIGS. 19 to 20. First, with reference to the left view of FIG. 19 and FIG. 20, driving of the lens by the autofocus function of the camera module 101 will be described.

The first voice coil motor that realizes the autofocus function, as shown in the left view of FIG. 19, includes the magnet 171a placed on the lens barrel 103 and magnetized so that the upper part and the lower part are an N pole and an S pole, and the coil 172a and the yoke 173a placed on the housing 104. The yoke 173a is made of, for example, a soft magnetic material such as iron with few impurities, which focuses a magnetic flux generated by the magnet 171a. Although there is one more first voice coil motor, only the first coil motor including the magnet 171a, the coil 172a and the yoke 173a will be described hereinafter.

Applying electric current to the coil 172a causes a drive force for moving the lens barrel 103 along the direction of the optical axis of the lens 102. To be specific, when electric current is applied to the coil 172a, because of the direction of the electric current and a magnetic flux (see an arrow Y1) passing through the coil 172a from the magnet 171a, the lens barrel 103 is caused to reciprocate along the direction of the optical axis of the lens 102 (a direction of an arrow Y21 in FIG. 20: the Z-axis direction) in accordance with the Fleming's left-hand rule.

The lens barrel 103 is equipped with the main guide ball 176 and the sub guide ball 177 that come in contact with the housing 104, and the lens barrel 103 is kept pressed against both the guide balls 176 and 177 by the two first voice coil motors. To be specific, magnetic forces shown with arrows Y11 and Y12 in FIG. 20 are caused at the two first voice coil motors, so that a resultant force Y13 of the magnetic forces is applied to the lens barrel 103. Thus, the lens barrel 103 keeps pressing the main guide ball 176 toward the corner along the diagonal line.

Further, as shown in FIG. 20, the magnetic forces Y11 and Y12 acting on the two first voice coil motors are different in strength from each other. To be specific, as shown in FIG. 17, the outline of the yoke 173b corresponding to the magnet 171b included by one of the first voice coil motors is larger than the outline of the yoke 173a corresponding to the magnet 171a included by the other first voice coil motor. Therefore, the magnetic force Y12 by which the magnet 171b of the one first voice coil motor is attracted laterally is stronger than the magnetic force Y11 by which the magnet 171a of the other is attracted laterally. Then, by a resultant force of the magnetic forces Y11 and Y12, the lens barrel 103 is pressed so as to rotate about the main guide ball 176 as shown with an arrow Y14. As a result, the lens barrel 103 pushes the sub guide ball 177 in almost the vertical direction to the diagonal line, and the sub guide ball 177 supports the push.

Consequently, the lens barrel 103 keeps in contact with the housing 104 via the main guide ball 176 and the sub guide ball 177. Then, its movement in the vertical direction to the optical axis in the housing 104 is controlled, and its posture becomes stable. As a result, it is possible to realize a stable autofocus operation without instability of the optical axis.

Magnetic fluxes passing through the yokes 173a and 173b from the magnets 171a and 171b are produced at the two first voice coil motors, and then, the yokes 173a and 173b each have a property of seeking to take the magnetic fluxes from the magnets 171a and 171b as much as possible. Therefore, the yokes 173a and 173b act so as to be located opposite the respective centers of the magnets 171a and 171b, that is, opposite the respective boundaries of the N poles and the S poles. With such magnetic levitation, the lens barrel 103 connected with the magnets 171a and 171b levitates so that the yokes 173a and 173b are located at the respective boundaries of the N poles and the S poles of the magnets 171a and 171b. Moreover, when the lens barrel 103 connected with the magnets 171a and 171b moves in accordance with the Fleming's left-hand rule and the yokes 173a and 173b are thereby dislocated upward or downward with respect to the respective centers of the magnets 171a and 171b, a magnetic spring effect, which is trying to turn back to the original position with a magnetic force, arises.

Thus, the lens barrel 103 connected with the magnets 171a and 171b is stably located in a position corresponding to positions where the yokes 173a and 173b are installed. Therefore, by setting a position of the lens barrel 103 with magnetic levitation to a predetermined position such as a focus position, which is frequently used, it is possible to control driving of the lens barrel 103 by the first voice coil motors described above, and it is possible to achieve power saving.

Next, with reference to the right view of FIG. 19 and FIG. 20, driving of the lens by the stabilizer function of the camera module 101 will be described.

The second voice coil motor that realizes the stabilizer function, as shown in the right view of FIG. 19, includes the magnet 174b magnetized so as to be an N pole and an S pole and placed on the housing 104, and the coil 175b placed on the bottom cover 106. Although there is one more second voice coil motor, only the second voice coil motor including the magnet 174b and the coil 175b will be described hereinafter.

Applying electric current to the coil 175b causes a drive force moving the housing 104 housing the lens barrel 103 along a predetermined one direction on a vertical plane to the direction of the optical axis of the lens 102. To be specific, when electric current is applied to the coil 175b, because of the direction of the electric current and a magnetic flux (see an arrow Y2) passing through the coil 175b from the magnet 174b, the housing 104 is driven to reciprocate along one linear direction on a vertical plane to the direction of the optical axis of the lens 102 (along a direction of an arrow Y22 in FIG. 20: the X-axis direction) in accordance with the Fleming's left-hand rule. By the magnet 174a and the coil 175a included by the other second voice coil motor, the housing 104 is driven to reciprocate along a linear direction (the Y-axis direction) orthogonal to the abovementioned one linear direction (the X-axis direction) on the vertical plane to the optical axis direction of the lens 102. That is, by the two second voice coil motors, the housing 104 is driven to reciprocate in the respective linear directions orthogonal to each other on the vertical plane to the optical axis direction of the lens 102.

The housing 104 and the bottom cover 106 are attracted and connected to each other by the connection springs 179 with the support guide ball 178 therebetween. Thus, the housing 104 is driven by the second voice coil motors to reciprocate on the bottom cover 106 with the support guide ball 178 as a guide. In addition, the connection spring 179 has flexibility in a direction vertical to the direction of the optical axis of the lens 102, so that the connection spring 179 bows as shown with an arrow Y23 in FIG. 20 at the time of driving by the second voice coil motors. However, the connection spring 179 urges the housing 104 and the bottom cover 106 to attract each other, so that the housing 104 and the bottom cover 106 keep connected at a distance for the diameter of the support guide ball 178b at all times. Therefore, the magnets 174a and 174b placed on the housing 104 and the coils 175a and 175b placed on the bottom cover 106 included by the second voice coil motors maintain constant distances from each other at all times. As a result, driving by the second voice coil motors become stable.

Further, the second voice coil motor has a structure guided by the support guide ball 178 as described above, so that the second voice coil motor has high reliability, for example, ability to avoid a fall. Moreover, the second voice coil motor having the abovementioned structure is not a spring-mass system and therefore does not have a resonance system. Also from such a viewpoint, it is possible to increase reliability.

The installation positions of the first voice coil motors and the installation positions of the second voice coil motors are not limited to those described above, and the first and second voice coil motors may be installed at any positions. Moreover, the shapes of the components included by the voice coil motors are not limited to those described above, and the numbers of the components may be any numbers.

Further, in this exemplary embodiment, as for the first voice coil motors, a case where the lens barrel 103 has the magnets 171a and 171b, the housing 104 has the coils 172a and 172b and the yokes 173a and 173b has been described. However, on the contrary, the lens barrel 103 may have the coils 172a and 172b and the yokes 173a and 173b, and the housing 104 may have the magnets 171a and 171b. Moreover, in this exemplary embodiment, as for the second voice coil motors, a case where the housing 104 has the magnets 174a and 174b and the bottom cover 106 has the coils 175a and 175b has been described, but on the contrary, the housing 104 may have the coils 175a and 176b, and the bottom cover 106 may have the magnets 174a and 174b.

### Fourth Exemplary Embodiment

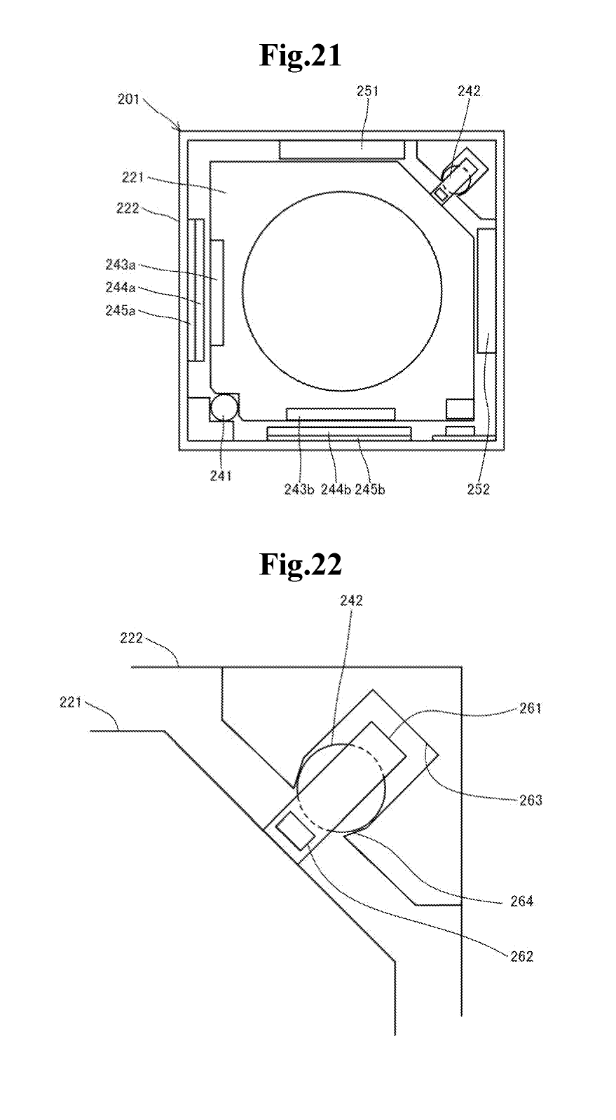

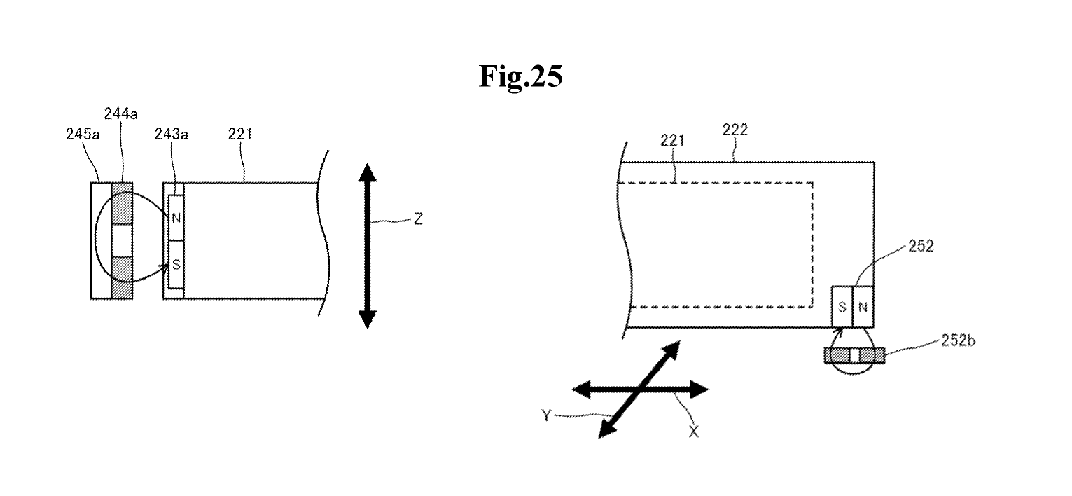

A fourth exemplary embodiment of the present invention will be described with reference to FIGS. 21 to 25. FIGS. 21 to 23 are views showing a configuration of a camera module. FIGS. 24 and 25 are views showing an operation of the camera module.

The camera module according to the present invention is, for example, for taking an image, mounted on an information processing terminal such as a smartphone and a tablet terminal. However, the camera module according to the present invention is not necessarily limited to being mounted on an information processing terminal, and may be mounted on other electronic equipment or various types of equipment.

The camera module according to the present invention includes a lens drive unit 201 that has an autofocus function and a stabilizer function; the autofocus function automatically focuses at the time of taking an image of an object, and the stabilizer function optically compensates for camera shake occurring at the time of taking an image to reduce blur of the image. Hereinafter, a configuration of the lens drive unit 201 that realizes the autofocus function and the stabilizer function will be mainly described. Meanwhile, the lens drive unit 201 may have a function other than the functions illustrated in this exemplary embodiment.

First, the overall configuration of the lens drive unit 201 will be described with reference to FIG. 21. FIG. 21 shows a plan view of the lens drive unit 201. The drawings of this application show the configuration in a partially omitted manner so that its structure becomes clear.

First, the lens drive unit 201 includes a cover (not shown in the drawings) that covers the top and a bottom cover (not shown in the drawings) that covers the bottom. The lens drive unit 201 then includes a lens barrel 221 equipped with a lens (not shown in the drawings) and a housing 222 surrounding the lens barrel 221 to house the lens barrel 221, inside the cover and the bottom cover that are not shown in the drawings. In addition, the lens drive unit 201 includes two first voice coil motors 243-245 that move the lens barrel 221 along the direction of the optical axis of the lens with respect to the housing 222, and first guide mechanisms 241 and 242 that guide movement of the lens barrel 221 with respect to the housing 222. Mainly, by the first voice coil motors 243-245 and the first guide parts 241 and 242, the autofocus function of the lens is realized.

Further, the housing 222 is supported by the bottom cover (not shown in the drawings) on the bottom face side of the lens, and the lens drive unit 201 includes second voice coil motors 251 and 252 that move the housing 222 in a vertical direction to the direction of the optical axis of the lens with respect to the bottom cover. In addition, the lens drive unit 201 includes second guide mechanisms (not shown in the drawings) that are placed between the housing 222 and the bottom cover to guide movement of the housing 222 with respect to the second voice coil motors 251 and 252, and connection springs (not shown in the drawings) that connect the housing 222 to the bottom cover. Mainly by these components, the lens stabilizer function is realized.

Further, the lens drive unit 201 includes a FPC (Flexible Printed Circuit) and other components. Hereafter, the respective components will be described.

As shown in FIG. 21, the lens barrel 221 has a substantially rectangular outline. At the center of the lens barrel 221, a lens housing hole that houses the lens is formed.

Next, the first voice motors that realize the lens autofocus function will be described. Of the side faces of the lens barrel 221, in the vicinity of two neighboring sides of the substantially rectangular outline, magnets 243a and 243b configuring the first voice coil motors are placed, respectively. Moreover, coils 244a and 244b and yokes 245a and 245b configuring the first voice coil motors are placed on the housing 222 so as to be opposite the magnets 243a and 243b, respectively. Thus, the first voice coil motors that realize the autofocus function are placed at places corresponding to the two neighboring sides of the substantially rectangular outline.

Further, a main guide part is formed at a position corresponding to a corner sandwiched by the two neighboring sides with the two first voice coil motors 243-245 placed of the substantially rectangular lens barrel 221. To be specific, a first guide ball retaining part configuring the main guide part is formed at the corner of the lens barrel 221 sandwiched by the abovementioned two first voice coil motors 243-245. The first guide ball retaining part is formed by a groove along the direction of the optical axis of the lens, and the groove is open outward on a diagonal line passing through the corner where the groove is formed. Then, the first guide ball retaining part retains a spherical main guide ball 241 configuring the main guide part, in a rotatable manner. The main guide ball 241 is pressed against and supported by a first guide ball support part to be described later, which is formed on the inner face of the housing 222, configures the main guide part and has a concave shape. Consequently, the main guide ball 241 rotates in the groove serving as the first guide ball retaining part and, with this, the lens barrel 221 is guided by the main guide ball 241 to move along the direction of the optical axis of the lens. Herein, any number of main guide balls 241 may be retained.

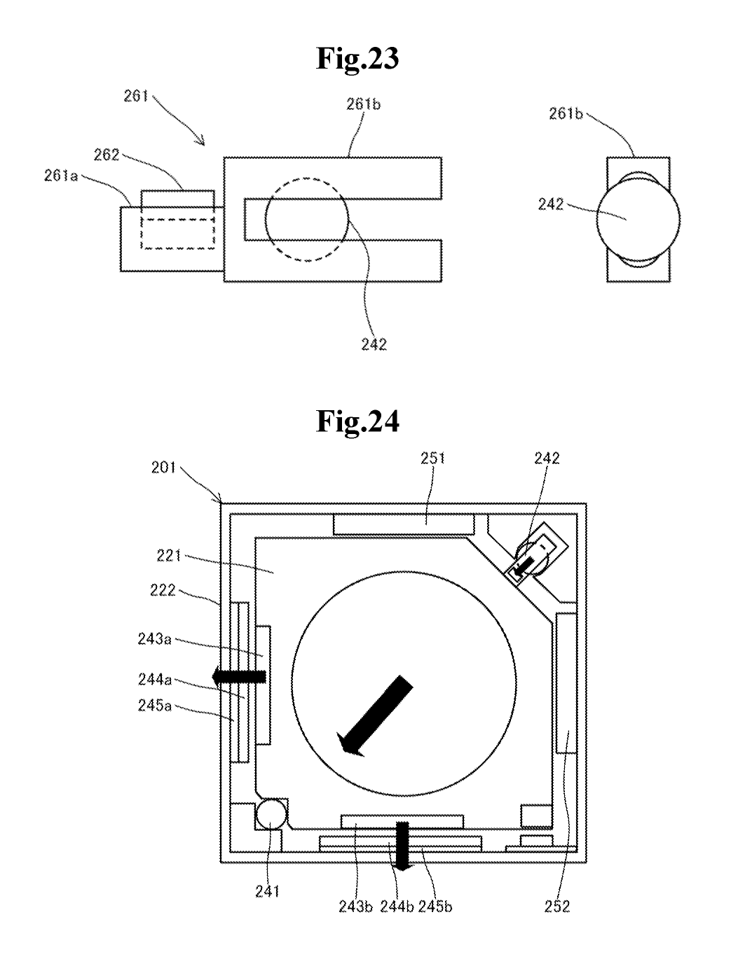

Further, on the lens barrel 221, a sub guide part is formed at the other corner located diagonally to the corner where the first guide ball retaining part is formed. To be specific, at the abovementioned corner of the lens barrel 221, a retaining mechanism 261 and a sub guide ball 242 configuring the sub guide part are placed. The retaining mechanism 261 is connected to the abovementioned corner on the outer perimeter of the lens barrel 221 and is formed so as to extend from that corner toward a corner inside the housing 222. To be specific, as shown in FIGS. 22 and 23, the retaining mechanism 261 includes a base part 261a and a retaining part 261b; the base part 261a is connected to the outer perimeter of the lens barrel 221, and the retaining part 261b extends from the base part 261a and is made of two joist members located in parallel along the direction of the optical axis of the lens. The retaining part 261b retains the sub guide ball 242 between the two joist members. In this case, a retaining face of the retaining part 261b, located between the two joist members, is formed into a concave shape as shown in FIG. 23, and retains the sub guide ball 242 contacting at a point or a little area. The two joist members of the retaining part 261b retain the sub guide ball 242 so that the sub guide ball 242 can rotate and move in the direction of the optical axis and can also move along a longitudinal direction of the two joist members.

At a corner position of the housing 222, opposite the corner position of the lens barrel 221 where the retaining mechanism 261 and the sub guide ball 242 are placed, a concave part 263 configuring a sub guide part to house the retaining part 261b and the sub guide ball 242 is formed. To be specific, the concave part 263 is formed like a groove along the lens optical axis direction at the corner position inside of the housing 222. An opening 264 of the concave 263 is formed so as to have a smaller cross-sectional area than an inner space of the concave 263. Consequently, as shown in FIG. 22, a tip of the retaining part 261b can be inserted into the concave 263, but the sub guide ball 242 retained inside the retaining part 261b is caught in the concave 263 by the opening 264 formed narrow and is prevented from protruding outside from inside the concave 263.

Further, as shown in FIGS. 22 and 23, on the base part 261a of the retaining mechanism 261, a magnet 262 is placed. That is, the magnet 262 is not inserted into the concave 263 formed on the housing 222, and is placed on the base part 261a that is located closer to the lens barrel than the concave 263 and in the vicinity of the root of the retaining part 261b. Thus, the sub guide ball 242 is made of a magnetic material such as iron attracted by a magnet. Consequently, in the sub guide part 242, the sub guide ball 242 housed in the housing 222 by the retaining mechanism 261 keeps attracted toward the lens barrel at all times and remains in contact with the inside wall near the opening of the concave 263. In this case, the sub guide ball 242 is retained so as to rotate along the lens optical axis direction in the concave 263, so that the lens barrel 221 can move along the lens optical axis direction.

As described above, the first voice coil motors 243-245 that realize the autofocus function in this exemplary embodiment are placed on the two neighboring sides of the substantially rectangular lens barrel 221, respectively, and the magnets 243a and 243b are magnetically attracted to the yokes 245a and 245b, respectively. That is, the two first voice coil motors 243-245 cause magnetic forces shown in FIG. 24, and a resultant force thereof is applied to the lens barrel 221. Therefore, a force that the lens barrel 221 presses the main guide ball 241 diagonally toward the corner is applied.

In this case, the sub guide ball 242 located on the corner diagonally opposite the main guide ball 241 is caught in the concave 263 by the opening 264 and, as shown in FIG. 24, is diagonally attracted by the magnet 262 toward the main guide ball 241. In addition, the retaining mechanism 261 equipped with the magnet 262 is integrated with the lens barrel 221, so that it is attracted toward the main guide ball 241. Therefore, a force that the lens barrel 221 pulls the housing 222 toward the main guide ball 241 via the mechanism of the sub guide part including the sub guide ball 242 and so on is applied.

The lens barrel 221 is in contact with the housing 222 with no space via the main guide ball 241 and the sub guide ball 242, so that it can inhibit occurrence of rattling. Thus, movement in the vertical direction to the optical axis in the housing 222 is controlled and the posture becomes stable. As a result, it is possible to realize a stable autofocus function without instability of the optical axis.

The magnet 243a of the first voice coil motor 243-245 is magnetized so that the upper part and the lower part are an N pole and an S pole on the side of the lens barrel 221 as shown in the left view of FIG. 25. Applying electric current to the coil 244a in such a configuration causes a drive force for moving the lens barrel 221 along the lens optical axis direction. To be specific, when electric current is applied to the coil 244a, because of the direction of the electric current and a magnetic flux passing through the coil 244a from the magnet 243a, the lens barrel is caused to reciprocate along the lens optical axis direction (the Z-axis direction) in accordance with the Fleming's left-hand rule. Consequently, the autofocus function can be realized.

Next, the second voice coil motors 251 and 252, which are configurations realizing the lens stabilizer function, will be described. The second voice coil motors include the two voice coil motors 251 and 252 and allow for movement of the housing 222 itself that houses the lens barrel 221 with respect to the bottom cover. In this case, as shown in FIG. 21, the two voice coil motors 251 and 252 are placed, respectively, near two neighboring sides that are different from the two sides where the first voice coil motors 243-245 are placed of the four sides forming the outer perimeter of the substantially rectangular lens derive unit 201. That is, the two voice coil motors 251 and 252 are placed, respectively, near the two sides orthogonal to each other.

One voice coil motor 251 is installed in the vicinity of a side located on the upper side in FIG. 21, and moves the housing 222 in the vertical direction. The other voice coil motor 252 is installed in the vicinity of a side located on the right side in FIG. 21, and moves the housing 222 in the horizontal direction. Thus, the two voice coil motors 251 and 252 can move in two linear directions orthogonal to each other on a vertical place to the lens optical axis direction.

To be specific, one of the voice coil motors includes the magnet 251 placed on the lower face of the housing 222 and a coil (not shown in the drawings) installed on the bottom cover so as to correspond to the magnet 251. Likewise, the other voice coil motor includes, as shown in the right view of FIG. 25, the magnet 252 placed on the lower face of the housing 222 and a coil 252b installed on the bottom cover so as to correspond to the magnet 252. Then, the one voice coil motor including the magnet denoted by reference numeral 251 shown in FIG. 21 allows movement along one linear direction (Y-axis direction) on the vertical plane to the lens optical axis direction when electric current is applied to the coil (not shown in the drawings) corresponding to the magnet 251. Moreover, the other voice coil motor including the magnet denoted by reference numeral 252 allows movement along the other linear direction (X-axis direction) that is orthogonal to the one linear direction on the vertical plane to the lens optical axis direction when electric current is applied to the coil 252b corresponding to the magnet 252.

Thus, the lens drive unit 201 according to the present invention can realize movement in the lens optical axis direction with the first voice coil motors 243-245, and can realize movement in the vertical direction to the lens optical axis direction with the second voice coil motors 251 and 252. Then, it is possible to prevent the lens barrel from rattling by magnetic forces generated by the first voice coil motors 243-245, and it is possible to realize a stable autofocus function without instability of the optical axis.

Meanwhile, in the lens drive unit 201 in this exemplary embodiment, the second voice coil motors 251 and 252 are illustrated as a configuration for realizing movement in the vertical direction to the lens optical axis direction, but the configuration for realizing movement in the vertical direction may be any configuration.

### Fifth Exemplary Embodiment

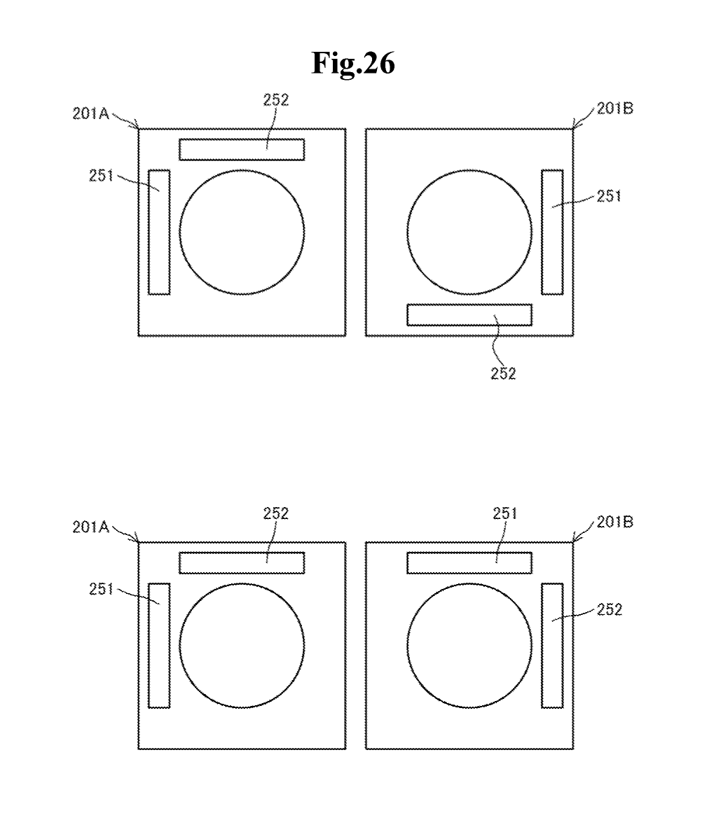

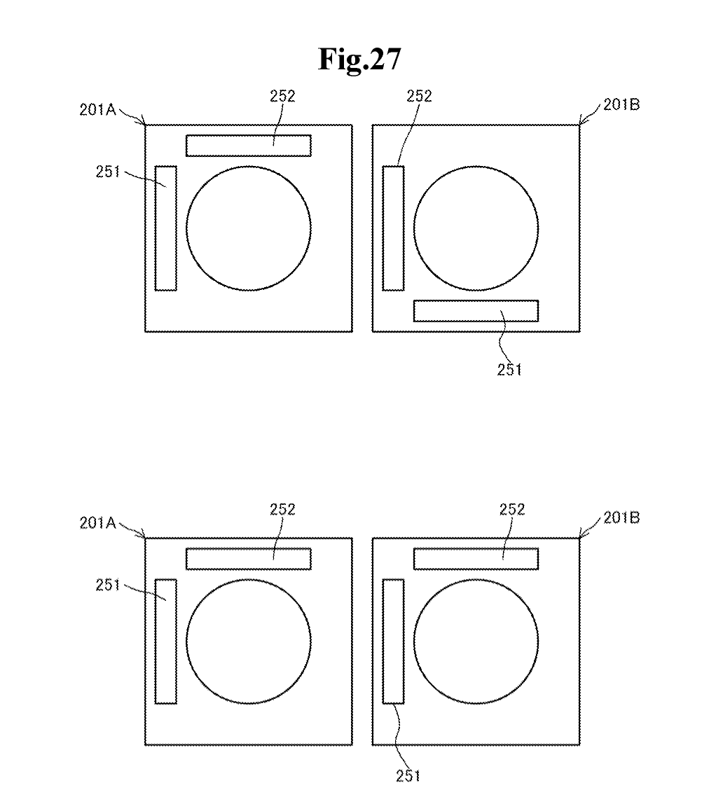

Next, a fifth exemplary embodiment of the present invention will be described with reference to FIGS. 26 to 27. A camera module according to the present invention is a dual camera including two cameras. Therefore, the camera module includes two lens drive units described in the exemplary embodiment 4 (denoted by reference numerals 201A and 201B).

In configuring the dual camera with the two lens drive units 201A and 201B, the lens drive units 201A and 201B are arranged adjacent to each other. For example, the lens drive units 201A and 201B are formed so as to have substantially square outlines and are arranged so that one sides of the outer peripheries are in parallel and adjacent to each other. The outlines of the lens drive units 201A and 201B are not limited to a square, and may be formed so as to be substantially rectangular.

In this exemplary embodiment, the abovementioned two lens drive units 201A and 201B configuring the dual camera are arranged as shown in FIG. 26 or 27. In FIGS. 26 and 27, only the magnets 251 and 252 of the second voice coil motors 251 and 252 that are components for realizing the lens stabilizer function described in the fourth exemplary embodiment are illustrated as the components of the lens drive units 201A and 201B. That is, the arrangement of the magnets 251 and 252 of the second voice coil motors is important.

The two voice coil motors 251 and 252 are arranged, respectively, in the vicinity of two neighboring sides of the four sides forming the outer perimeter of the substantially rectangular lens drive unit 201A as described above. In this exemplary embodiment, it is desirable to arrange the magnets 251 and 252 configuring the two voice coil motors so as not to be located on sides where the lens drive units 201A and 201B are located adjacent to each other.

To be specific, in an example shown in the upper view of FIG. 26, one lens drive unit 201A located on the left is placed so that the magnets 251 and 252 are located in the vicinity of the left side and in the vicinity of the upper side of the outer perimeter, and the other lens drive unit 201B located on the right is placed so that the magnets 251 and 252 are located on the right side and the lower side. Thus, the lens drive units 201A and 201B are arranged so that the magnets 251 and 252 configuring the stabilizer functions of the lens drive units 201A and 201B are located so as to be point-symmetric with respect to the vicinity of the midpoints of the sides where the lens drive units are located adjacent to each other. Consequently, none of the magnets 251 and 252 are located in positions where the lens drive units 201A and 201B are adjacent to each other, so that magnetic interference can be inhibited.

Further, in an example shown in the lower view of FIG. 26, one lens drive unit 201A located on the left is placed so that the magnets 251 and 252 are located in the vicinity of the left side and in the vicinity of the upper side of the outer perimeter, and the other lens drive unit 201B located on the right is placed so that the magnets 251 and 252 are located in the vicinity of the upper side and in the vicinity of the right side. Thus, the lens drive units 201A and 201B are arranged so that the magnets 251 and 252 configuring the stabilizer functions of the lens drive units 201A and 201B are located so as to be line-symmetric with respect to sides where the lens drive units 201A and 201B are located adjacent to each other. Consequently, none of the magnets 251 and 252 are located in positions where the lens drive units 201A and 201B are adjacent to each other, so that magnetic interference can be inhibited.

Further, in this exemplary embodiment, the abovementioned two lens drive units 201A and 201B configuring the dual camera may be installed so that none of the magnets 251 and 252 configuring the voice coil motors are not located on one of sides where the lens drive units 201A and 201B are located adjacent to each other.

To be specific, in an example shown in the upper view of FIG. 27, one lens drive unit 201A located on the left is placed so that the magnets 251 and 252 are located in the vicinity of the left side and in the vicinity of the upper side of the outer perimeter, and the other lens drive unit 201B located on the right is placed so that the magnets 251 and 252 are located in the vicinity of the lower side and in the vicinity of the left side. Thus, even if the magnet 252 of the lens drive unit 201B is located between the lens drive units 201A and 201B, magnetic interference can be inhibited.

Further, in an example shown in the lower view of FIG. 27, one lens drive unit 201A located on the left is placed so that the magnets 251 and 252 are located in the vicinity of the left side and in the vicinity of the upper side on the outer perimeter, and the other lens drive unit 201B located on the right is placed so that the magnets 251 and 252 are located in the vicinity of the left side and in the vicinity of the upper side. Thus, even if the magnet 252 of the lens drive unit 201B is located between the lens drive units 201A and 201B, magnetic interference can be inhibited.

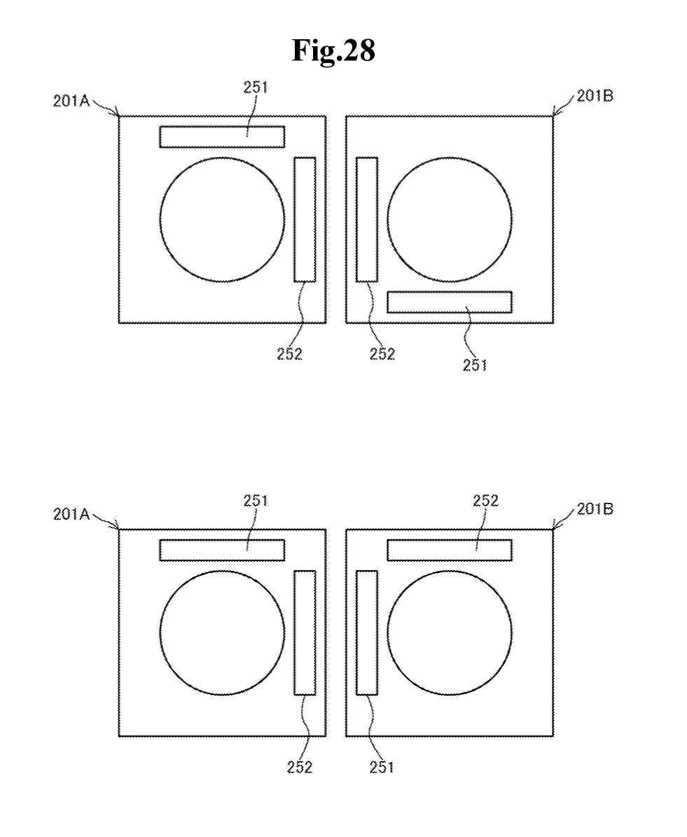

Meanwhile, examples shown in the upper and lower views of FIG. 28 are examples for comparison with the configurations in this exemplary embodiment shown in FIGS. 26 and 27. As shown in the upper and lower views of FIG. 28, in a case where the magnets 251 and 252 configuring the stabilizer functions of the lens drive units 201A and 201B are located on the sides where the lens drive units 201A and 201B are located adjacent to each other, the magnets 251 and 252 may cause magnetic interference. Therefore, the arrangements shown in FIGS. 26 and 27 are desirable.

Herein, on the sides where the lens drive units 201A and 201B are located adjacent to each other, at least one of the magnets 243a and 243b of the first voice coil motors for realizing the autofocus function is located. In other words, the magnets 243a and 243b of the first voice coil motors are located adjacent to each other in the example shown in FIG. 26, and one magnet (243a or 243b) of the first voice coil motor and one magnet (251 or 252) of the second voice coil motor are adjacent to each other in the example shown in FIG. 27. However, the first voice coil motors for autofocus include the yokes 24a and 245b outside the magnets 243a and 243b. Therefore, magnetic interference between the magnets adjacent to each other can be inhibited.

As described above, according to the camera module of the present invention shown in FIGS. 26 and 27, the voice coil motors for realizing the stabilizer functions of the lens drive units configuring the dual camera are not placed adjacent to each other, so that magnetic interference can be inhibited. As a result, it is possible to prevent decrease of the stabilizer function of the lens drive unit.

Although the present invention has been described above with reference to the exemplary embodiments and so on, the present invention is not limited to the exemplary embodiments. The configurations and details of the present invention can be altered and changed in various manners that can be understood by one skilled in the art within the scope of the present invention.

1. A lens drive unit comprising:
a voice coil motor installed around a lens barrel equipped with a lens, the voice coil motor being configured to move the lens barrel along an optical axis of the lens; and
a guide part configured to guide movement of the lens barrel along the optical axis of the lens with respect to a housing configured to house the lens barrel, wherein:
the voice coil motor includes a magnet that is installed on one of the housing and the lens barrel and a coil and a yoke that are installed on the other, and the yoke is configured to concentrate a magnetic flux produced by the magnet; and
the yoke is placed so as to press the lens barrel against the guide part by a magnetic force by which the yoke is attracted to the magnet.

2. The lens drive unit according to claim 1, wherein:
at least two voice coil motors are arranged around the lens barrel; and
yokes included by the at least two voice coil motors are arranged so as to press the lens barrel against the guide part by a resultant force of magnetic forces by the yokes.

3. The lens drive unit according to claim 2, wherein:
the guide part is placed in a middle position between the two voice coil motors around the lens barrel; and
the yokes included by the two voice coil motors are arranged so as to press the lens barrel against the guide part by a resultant force of magnetic forces by the yokes.

4. The lens drive unit according to claim 3, wherein the voice coil motors are installed in positions corresponding to centers of neighboring side walls of the housing that has a rectangular shape.

5. The lens drive unit according to claim 4, wherein the yoke is formed so that its portion on a side where the guide part is located is larger in cross section than its portion on a side where the guide part is not located.

6. The lens drive unit according to claim 4, wherein the yoke has a T-shaped form and is installed so that a head part of the T-shaped form is placed closer to the guide part.

7. The lens drive unit according to claim 4, wherein a magnetic force by which the yoke included by the voice coil motor installed on one of the neighboring side walls of the housing is attracted to the magnet is different from a magnetic force by which the yoke included by the voice coil motor installed on the other is attracted to the magnet.

8. The lens drive unit according to claim 4, wherein a thickness of the yoke included by the voice coil motor installed on one of the neighboring side walls of the housing that has the rectangular shape is different from a thickness of the yoke included by the voice coil motor installed on the other.

9. The lens drive unit according to claim 8, further comprising a second guide part on an opposite side from the guide part across the lens barrel, wherein:
the second guide part includes a guide ball and a retaining member that is configured to retain the guide ball in a rotatable manner and a guide ball support part against which the guide ball is pressed by the retaining member, the guide ball and the retaining member and the guide ball support part are arranged so that the retaining member retains the guide ball from one side with respect to a line passing through a center of the lens and connecting the guide part with the second guide part and so that the guide ball support part is located on the other side; and
the thickness of the yoke is regulated so that the retaining member presses the guide ball against the guide ball support part by a magnetic force by which the yoke is attracted to the magnet.

10. The lens drive unit according to claim 9, wherein:
the voice coil motors are placed on a side where the retaining member is placed and on a side where the guide ball support part is placed, respectively, with respect to the line passing through the center of the lens and connecting the guide part with the second guide part; and
the thicknesses of the yokes are regulated so that the yoke of the voice coil motor on the side where the retaining member is placed is thinner than the yoke of the voice coil motor on the side where the guide ball support part is placed.

11. The lens drive unit according to claim 1, wherein the yoke and the magnet are placed so that a position of the lens barrel with respect to the housing becomes a predetermined position with magnetic levitation by the yoke and the magnet.

12. A camera module equipped with the lens drive unit according to claim 1.

13. A lens drive unit comprising:
a lens barrel equipped with a lens;
a housing installed around the lens barrel and configured to house the lens barrel;
a first voice coil motor configured to move the lens barrel along an optical axis of the lens with respect to the housing; and
a first guide part configured to guide movement of the lens barrel with respect to the housing,
wherein the first voice coil motor includes a magnet that is installed on one of the housing and the lens barrel and also includes a coil and a yoke that are installed on the other, and the yoke is placed so as to press the lens barrel against the first guide part by a magnetic force by which the yoke is attracted to the magnet,
the lens drive unit further comprising:
a support cover configured to support the housing on one face side of the lens;
a second voice coil motor configured to move the housing in a vertical direction to the optical axis of the lens with respect to the support cover;
a second guide part placed between the housing and the support cover so as to come in contact with the housing and the support cover and configured to guide movement of the housing with respect to the support cover; and
a connection member configured to connect the housing to the support cover, wherein:
the second voice coil motor includes a magnet installed on one of the housing and the support cover and also includes a coil and a yoke installed on the other; and
the connection member is configured to connect the housing to the support cover with a constant distance kept.

14. The lens drive unit according to claim 13, wherein the connection member is configured to apply a force attracting the housing and the support cover to each other via the second guide part.

15. The lens drive unit according to claim 13, wherein the connection member is configured to be flexible in the vertical direction to the optical axis of the lens.

16. The lens drive unit according to claim 13, wherein the connection member includes a tension spring configured to apply a force attracting the housing and the support cover to each other.

17. The lens drive unit according to claim 13, wherein the second guide part includes a plurality of spherical objects arranged at positions previously set with respect to the support cover and configured to rotate at the arranged positions.

18. The lens drive unit according to claim 13, wherein the second voice coil motor includes two voice coil motors configured to respectively move the housing in two linear directions orthogonal to each other on a vertical plane to the optical axis of the lens.

19. The lens drive unit according to claim 13, wherein:
the first voice coil motors are arranged at positions on two neighboring sides of the lens barrel having a substantially rectangular shape;
the first guide part is placed in a middle position between the two first voice coil motors; and
the yokes of the two first voice coil motors are arranged so as to press the lens barrel against the first guide part by a resultant force of magnetic forces by the respective yokes.

20. The lens drive unit according to claim 19, wherein:
the first guide part includes a main guide part and a sub guide part, the main guide part is placed near a corner between the two neighboring sides where the two first voice coil motors are arranged of the lens barrel having the substantially rectangular shape, and the sub guide part is placed near the other corner located diagonally to the corner where the main guide part is placed of the lens barrel having the substantially rectangular shape;
the magnetic forces by which the yokes included by the two first voice coil motors are attracted to the magnets are differentiated from each other; and
the sub guide part is configured to support press by the lens barrel urged to rotate about the main guide part by a resultant force of the magnetic forces by the respective yokes of the two first voice coil motors.

21. The lens drive unit according to claim 19, wherein two voice coil motors serving as the second voice coil motor are arranged near positions on the other two sides that are different from the two neighboring sides where the first voice coil motors are arranged of the lens barrel having the substantially rectangular shape, and the two voice coil motors respectively move the housing in two linear directions orthogonal to each other on a vertical plane to the optical axis of the lens.

22. A lens drive unit comprising:
a lens barrel equipped with a lens;
a housing installed around the lens barrel and configured to house the lens barrel;
a voice coil motor configured to move the lens barrel along an optical axis of the lens with respect to the housing; and
a guide mechanism configured to guide movement of the lens barrel along the optical axis of the lens with respect to the housing, wherein:
the guide mechanism includes a main guide part and a sub guide part, the main guide part is placed in a predetermined position around the lens barrel, and the sub guide part is placed in another position located opposite the predetermined position around the lens barrel where the main guide part is placed, across the lens barrel; and
the voice coil motor includes a magnet installed on one of the housing and the lens barrel and also includes a coil and a yoke installed on the other, and is configured to apply a force pressing the lens barrel against the main guide part and a force by which the lens barrel pulls the housing via the sub guide part, by a magnetic force by which the yoke is attracted to the magnet.

23. The lens drive unit according to claim 22, wherein the sub guide part includes a housed member housed in a concave formed on an inner face of the housing and configured to move along the optical axis of the lens in the concave part, and the sub guide part is configured so that the housed member is caught inside the housing and pulled toward the lens barrel.

24. The lens drive unit according to claim 23, wherein an opening of the concave is formed so as to have a larger cross-sectional area than an internal space of the concave.

25. The lens drive unit according to claim 23, wherein the sub guide part includes a sub guide ball serving as the housed member housed in the concave, a retaining part connected to the lens barrel and configured to retain the sub guide ball in a manner rotatable along the optical axis of the lens, and a pulling member configured to pull the sub guide ball toward the lens barrel.

26. The lens drive unit according to claim 25, wherein:
the retaining part is configured to extend so as to be inserted in the internal space of the concave from the outer perimeter of the lens barrel, thereby sandwiching and retaining the sub guide ball along the optical axis of the lens and also retaining the sub guide ball in a manner movable along a direction in which the retaining member extends; and
the pulling member is formed by a magnet that pulls the sub guide ball toward the lens barrel by a magnetic force, and is placed near a root of the retaining member located closer to the lens barrel than the concave part of the housing.

27. The lens drive unit according to claim 22, further comprising a second voice coil motor configured to move the housing with the lens barrel housed in a vertical direction to the optical axis of the lens, wherein:
two voice coil motors are arranged near two neighboring sides of an outer perimeter of the lens barrel having a substantially rectangular shape;
two second voice coil motors are arranged near two neighboring sides of the outer perimeter of the lens barrel, different from where the voice coil motors are arranged;
the main guide part is placed near a corner between the two neighboring sides of the outer perimeter of the lens barrel where the two voice coil motors are arranged; and
the sub guide part is placed near another corner located diagonally to the corner of the lens barrel where the main guide part is placed, and the another corner is between the two neighboring sides of the outer perimeter of the lens barrel where the two second voice coil motors are arranged.

28. A camera module equipped with two lens drive units according to claim 27, the lens drive units being adjacent to each other, wherein the two lens drive units are installed so that none of the second voice coil motors are located on at least one of sides where the lens drive units are located adjacent to each other.

29. The camera module according to claim 28, wherein the two lens drive units are installed so that none of the second voice coil motors are located on sides where the lens drive units are located adjacent to each other.
